(19) United States
(12) Patent Application Publication
(10) Pub. No.: US 2023/0017850 A1
(43) Pub. Date: Jan. 19, 2023

(54) SYSTEMS AND METHODS FOR OBSTACLE DETECTION FOR A POWER MACHINE

(71) Applicant: Clark Equipment Company, West Fargo, ND (US)

(72) Inventors: Kyle Thorson, Seattle, WA (US); Brent Durkin, Bismarck, ND (US); Daniel Wood, Fargo, ND (US); Sam Fehringer, Fargo, ND (US); John Pfaff, Bismarck, ND (US)

(21) Appl. No.: 17/868,186

(22) Filed: Jul. 19, 2022

Related U.S. Application Data
(60) Provisional application No. 63/223,241, filed on Jul. 19, 2021.
(60) Provisional application No. 63/278,278, filed on Nov. 11, 2021.
(60) Provisional application No. 63/349,169, filed on Jun. 6, 2022.

(51) Int. Cl. E02F 9/26; E02F 9/20; G05D 1/02; G05D 1/00

(52) U.S. Cl. CPC E02F 9/26; E02F 9/205; G05D 1/005; G05D 1/0038; G05D 1/0214; G05D 1/0223; G05D 1/0238; G05D 1/0255; G05D 1/0257; G05D 2201/0202

(57) ABSTRACT

A retrofit kit for a power machine can include a detection module configured to be removably secured to the power machine to detect objects around the power machine. A control module can be configured to receive detected object data from the detection module and control the display module based on the detected object data to provide one or more indicators of an object detected by the detection module.

### CROSS-REFERENCE TO RELATED APPLICATIONS

This application claims priority to U.S. Provisional Pat. Application no. 63/223,241 filed Jul. 19, 2021, U.S. Provisional Pat. Application No. 63/278,278 filed Nov. 11, 2021, and U.S. Provisional Pat. Application No. 63/349,169 filed Jun. 6, 2022, the entirety of each of which is incorporated herein by reference.

### BACKGROUND

This disclosure is directed toward power machines. More particularly, this disclosure is directed to object detection and related arrangements of object detection devices for a power machine. Power machines, for the purposes of this disclosure, include any type of machine that generates power to accomplish a particular task or a variety of tasks. One type of power machine is a work vehicle. Work vehicles are generally self-propelled vehicles that have a work device, such as a lift arm (although some work vehicles can have other work devices) that can be manipulated to perform a work function. Work vehicles include loaders, excavators, utility vehicles, tractors, and trenchers, to name a few examples.

The discussion above is merely provided for general background information and is not intended to be used as an aid in determining the scope of the claimed subject matter.

### SUMMARY

According to some examples of the disclosure, object detection systems can be configured to monitor areas around a power machine to detect objects (e.g., static or moving entities or obstructions including pipes, barrels, poles, spoil piles, trees or stumps, rocks, other power machines or equipment, etc.). Operation of the power machine can then be automatically controlled based on the detected objects. In particular, some examples include one or more radar sensors or other object detection sensors that are configured to monitor an area that is opposite a primary lift arm, implement interface, or other work element of a power machine. Accordingly, automatic travel toward the monitored area ― i.e., in a direction that is generally opposite the primary lift arm, implement interface, or other work element ― can be controlled based on detection of objects by the sensor(s). In some cases, the monitored area and a corresponding direction of automatic travel of the power machine can be in a rearward direction for the power machine, relative to a default orientation of an operator station or other reference frame. In some cases, travel in such a direction can correspond to a primary path of automatic travel for the power machine.

According to some aspects of the disclosure, a power machine can include a main frame, and a lift arm pivotally secured to the main frame, the lift arm extending in a first direction away from main frame in a fully lowered configuration so that an implement interface secured to the lift arm is spaced apart from the main frame in the first direction. An object detection system can include an object detection sensor mounted to the power machine. The object detection sensor can be configured to monitor a detection zone for objects along a path of automatic travel that extends in a second direction that is opposite the first direction. A control device can be configured to execute automatic travel operations for the power machine based on signals from the object detection sensor.

In some examples, a sensor can be mounted to a movable tailgate of a power machine. A power machine can include a tailgate position sensor and a control device can be configured to execute automatic travel operations based on the tailgate position sensor sensing a current position of the movable tailgate. In some examples, a sensor can be mounted to a bumper of the power machine.

In some examples, a detection zone can extend from an apex of the detection zone located at the object detection sensor, along and around an object detection sensor axis extending from the apex. A cross-section of the detection zone at any of a plurality of locations along the object detection sensor axis can define a corresponding shape with a lower boundary. A sensor can be mounted to the power machine so that, with the power machine on level ground, a line extending from the apex through a plurality of the lower boundaries extends parallel with the level ground. In some examples, a sensor detection zone can form an elliptical cone. In some examples, with the power machine on level ground, a line extending from an apex through a plurality of lower boundaries of cross-sections of detection zones can be between 20 inches and 30 inches above the level ground.

In some example, the object detection sensor can be a first object detection sensor defining a first detection zone that extends from a first apex at the first object detection sensor, along and symmetrically around a first axis extending from the first apex. A power machine can include a second object detection sensor mounted to the power machine, the second object detection sensor defining a second detection zone that extends from a second apex at the second object detection sensor, along and symmetrically around a second axis, the second object detection sensor being configured to monitor a second detection zone for objects along the path of automatic travel in the second direction. A control device can be further configured to execute automatic travel operations for the power machine based on signals from the second object detection sensor.

In some examples, a first detection zone can overlap with a second detection zone. In some examples, at least one of a first detection-zone axis or a second detection-zone axis can extend at an oblique angle relative to a path of automatic travel. In some examples, the oblique angle can be about 15 degrees. In some examples, the first and second detection zones can collectively define opposed lateral boundaries of an object detection system, the opposed lateral boundaries extending outwardly from a main frame of a power machine, obliquely to a path of automatic travel.

In some examples, the object detection sensor can be a radar sensor. In some examples, a power machine can further include an ultrasonic sensor configured to detect obstacles in a non-detection zone for the radar sensor.

According to some aspects of the disclosure, a control system for a power machine can include an object detection sensor configured to monitor a detection zone for objects along a primary path of travel (e.g., automatic travel) that extends from the power machine in a first direction that extends opposite a primary implement interface of the power machine. A control device can be configured to execute operations including: when the power machine is moving or is commanded to move in the first direction, receiving signals from the object detection sensor that indicate detected objects in the detection zone; and providing an indication of the detected objects to an operator of a power machine.

In some examples, the control device can be further configured to control the travel of a power machine along a primary path of travel based on received signals from an object detection sensor that indicate detected objects. In some examples, the control of the travel of the power machine based on the received signals includes selective operation of the power machine in any one of a plurality of operating modes. The plurality of operating modes can include at least one of: a first operating mode that includes, based on the received signals that indicate the detected objects, reducing a current power machine speed relative to a commanded speed or relative to a maximum possible power machine speed; or a second operating mode that includes, based on the received signals that indicate the detected objects, causing the power machine to stop movement along the primary path of automatic travel.

In some examples, control of travel of a power machine based on received signals that indicate detected objects can include operation in a first operating mode that includes, based on the received signals that indicate the detected objects, reducing a current power machine speed relative to a commanded speed or relative to a maximum possible power machine speed. The reduction of the current power machine speed can be non-linear relative to changes in distance between the power machine and one or more of the detected objects.

In some examples, a control device can be further configured to provide an indication of detected objects by providing one or more of an auditory alert, a visual-display alert, or a tactile alert to the operator of the power machine, corresponding to at least one of the detected objects.

In some examples, a control system can include an object detection display. A control system can be configured to provide an indication of detected objects to an operator by providing a visual representation on the object detection display of a location and a distance of one or more of the detected objects relative to the power machine.

In some examples, a range of object detection for the object detection sensor can be controllable by an operator.

According to some aspects of the disclosure, a method is provided for method of controlling a power machine with an implement interface. The power machine can be automatically moved along a direction of travel opposite the implement interface. An object detection sensor can monitor for objects within a detection zone that extending in the direction of travel. If an object is detected in the detection zone, as indicated by the object detection sensor, the power machine can be automatically operated in an object-detected mode, including automatically controlling travel of the power machine along the direction of travel based on further monitoring of the object using the object detection sensor.

In some examples, operating a power machine in an object-detected mode can include automatically reducing a travel velocity of the power machine based on the detected object. In some examples, operating an object-detected mode can include automatically stopping the power machine based on detecting the detected object.

In some examples, operating a power machine in an object-detected mode can be overridden based on one or more of an actual travel speed or a commanded travel speed of the power machine being at or below a speed threshold. In some examples, the speed threshold can be 25% of a maximum power machine speed, or 10% of a maximum power machine speed.

According to some aspects of the disclosure, a control system for a power machine can include an object detection sensor configured to monitor a detection zone for objects along a primary path of travel. A control device can be configured to execute operations that include, when the power machine is moving or is commanded to move along the primary path of travel, receiving signals from the object detection sensor that indicate detected objects in the detection zone. The control device can also be configured to execute operations that include selecting an operational mode from among: a first operational mode configured slow the power machine to a stop when an object is detected in the detection zone; a second operational mode configured to slow but not stop the power machine when an object is detected in the detection zone; and a third operational mode configured to provide an alert to an operator of the power machine when an object is detected in the detection zone. The control device can also be configured to execute operations that include controlling the power machine during travel along the primary path of travel based on the received signals that indicate the detected objects and the selected operational mode.

In some examples, a control device can be further configured to determine, based on operator input, one or more of: a deceleration profile for first or second operational modes; or a minimum stopping distance for a first operational mode.

According to some aspects of the disclosure, retrofit kit for a power machine, the kit can include a detection module, and a control module. The detection module can be configured to be removably secured to the power machine to detect objects around the power machine. The control module can be configured to be installed in electronic communication with the detection module and a display module. A power module can be configured to be removably engaged with a power connection of the power machine to receive power from a power source of a power machine to power one or more of the detection module or the control module. The control module can be configured to receive object data from the detection module and communicate with the display module based on the radar data to provide one or more indicators of an object detected by the detection module.

In some examples, a retrofit kit can include a display module configured to be removably installed on a power machine. A display module can include an LED module configured to provide a plurality of light signals corresponding to a position of the detected object relative to the power machine. An LED module can include a one-dimensional LED array, and a control module can be configured to illuminate one or more select LEDs along the one-dimensional LED array to indicate a lateral position of a detected object or a proximity distance of the detected object. In some examples, a control module can be configured to illuminate one or more select LEDs with selected one or more colors of a plurality of colors to indicate a proximity distance and to illuminate the one or more select LEDs at selected one or more location along the one-dimensional LED array to indicate a lateral position. In some examples, a control module can be configured to select one or more colors to indicate a proximity distance based on a rated speed of a power machine.

In some examples, a detection module can include a magnetic coupler to magnetically secure the detection module to the power machine.

According to some aspects of the disclosure, a control system for a power machine can include an object detection sensor arranged to monitor a detection zone for objects along a path of travel of the power machine. A control device can be configured to execute operations including, when the power machine is moving along the path of travel, receiving signals from the object detection sensor that indicate detected objects in the detection zone. The control device can be further configured to execute operations including selectively providing an alert to an operator of the power machine for one or more of the detected objects, including: determining, based on the received signals, a direction of movement of a plurality of detected objects relative to the power machine; and providing the alert for the one or more detected objects based on the determined direction.

In some examples, a control module can be configured to provide a first alert based on a determined one or more directions of movement for one or more detected objects corresponding to a decreasing distance between the one or more objects and a power machine and not to provide the first alert based on the determined one or more directions corresponding to an increasing distance between the one or more objects and the power machine.

According to some aspects of the disclosure, a method of retrofitting a power machine is provided. A detection module can be secured to the power machine, with the detection module aligned to detect objects along a direction of travel of the power machine in electronic communication with a control module. A power module can be installed to be engaged with a power connection of the power machine to receive power from a power source of a power machine to power one or more of the detection module or the control module. The detection module can be thus arranged in communication with the control module so as to provide signals corresponding to objects detected by the detection module, and the control module can be configured to provide to an operator of the power machine one or more indicators of an object detected by the detection module.

In some examples, a power module can be removably installed on a power machine. Removably installing a power module can include removably engaging the power module with an auxiliary power connector of the power machine.

In some examples, the detection module can be removably secured to the power machine. Removably securing a detection module to a power machine can include magnetically securing the detection module at a rear of the power machine.

In some examples, a method of retrofitting a power machine can include installing a display module on the power machine in electronic communication with a control module. In some examples, a display module can be removably installed on a power machine. In some examples, removably installing a display module can include removably installing a one-dimensional LED array in an operator station of the power machine, or removably installing a display screen to display the one or more indicators within an operator station of the power machine

This Summary and the Abstract are provided to introduce a selection of concepts in a simplified form that are further described below in the Detailed Description. This Summary is not intended to identify key features or essential features of the claimed subject matter, nor are they intended to be used as an aid in determining the scope of the claimed subject matter.

### DRAWINGS

FIG. 1 is a block diagram illustrating functional systems of a representative power machine on which examples of the present disclosure can be advantageously practiced.

FIGS. 2-3 illustrate perspective views of a representative power machine in the form of a skid-steer loader of the type on which the disclosed examples can be practiced.

FIG. 4 is a block diagram illustrating components of a power system of a loader such as the loader illustrated in FIGS. 2-3.

FIG. 5 is a rear elevation view of a representative power machine with an object detection system according to an example of the present disclosure.

FIG. 6 is a side elevation view of a representation detection zone of the object detection system shown in FIG. 5.

FIG. 7 is top plan view of a representative detection zone of the object detection system shown in FIG. 5.

FIG. 8 is a block diagram illustrating a method for operating a power machine according to an example of the present disclosure.

FIG. 9 is a block diagram illustrating a method for installing and operating an object detection kit for power machine according to an example of the present disclosure.

FIG. 10 is a block diagram illustrating components of a power machine with a retrofit kit installed for object detection.

FIG. 11 is a perspective view of a rear portion of a representative power machine, with a retrofit kit for object detection installed on the power machine.

FIG. 12 is a perspective view of display modules for the retrofit kit of FIG. 11.

FIG. 13 is a view of an example user interface for one of the display modules of FIG. 12.

### DETAILED DESCRIPTION

The concepts disclosed in this discussion are described and illustrated by referring to particular examples. These concepts, however, are not limited in their application to the details of construction and the arrangement of components in the illustrative examples and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

Also as used herein, unless otherwise expressly limited or defined, the term “about” refers to a numerical value that is within ±10% of a reference value, inclusive (e.g., within ±8% or ±6%). For example, “about 100” refers to a range of values between 90 and 100, inclusive. Similarly, the term “substantially equal” refers to a numerical value that is within ±5% of a reference value, inclusive (e.g., within ±3% or ±1%). For example, “substantially equal to 100” refers to a range of values between 95 and 105, inclusive. In contrast, the term “substantially different” (e.g., expressed as “substantially more” or “substantially less”) refers to a numerical value that is more than 15% different (e.g., 15% more or 15% less) of a reference value, inclusive (e.g., more than 20% different or more than 30% different). For example, “substantially different from 100” refers to ranges of values that are more than 115 and less than 85, inclusive.

Also as used herein, unless otherwise expressly limited or defined, the term “automatic operations” (and the like) refers to operations that are at least partly dependent on electronic application of computer algorithms for decision-making without human intervention. In this regard, unless otherwise expressly limited or defined, “automatic travel” refers to travel of a power machine or other vehicle in which at least some decisions regarding steering, speed, distance, or other travel parameters are made without direct intervention by a human operator. Relatedly, the term “automated operations” (and the like), unless otherwise expressly limited or defined, refers to a subset of automatic operations for which no intervention by a human operator is required. For example, automated travel can refer to automatic travel of a power machine or other vehicle during which steering, speed, distance, or other travel parameters are determined in real time without operator input. In this regard, however, operator input may sometimes be received to start, stop, interrupt, or define parameters (e.g., top speed) for automated travel or other automated operations.

Also as used herein, unless otherwise expressly limited or defined, a “primary path of travel” of a power machine refers to a path of travel along which the power machine, during normal operation, is configure to travel at substantially full speeds (i.e., speeds substantially equal to a maximum permitted or possible speed for the power machine under a particular operating condition (e.g., with a fully loaded bucket, with an engine at maximum speed or power, on sloped terrain, with an experienced operator, etc.)). In this regard, for example, a primary path of travel may not be considered to extend in a backward direction for a power machine if the top speed of the power machine for any particular mode of operation in the backward direction (e.g., automatic, automated, or fully operator-controlled backward travel) is substantially less than the top speed of the power machine for the same particular mode of operation relative to travel in a forward direction. However, if a power machine can move in the backward direction at a top speed that is substantially similar to a top speed in the forward direction, movement in the rearward direction can be a primary path of travel (as well as the forward direction). Similarly, unless otherwise expressly limited or defined, a “primary” work element refers to a work element (e.g., an implement interface) that is oriented to the front of an operator station of a power machine or that is configured to be moved with a main (e.g., maximally powered) work actuator of a power machine.

Some of the discussion below describes object detection systems for power machines and related methods for operating a power machine. In some examples, an object detection system can be configured to detect objects along a path of travel of the power machine, wherein the path of travel is oriented in a direction that extends opposite an implement interface of a power machine. For example, the path of travel and the direction of detection of objects can extend to a rearward side of a power machine with an operator station, or otherwise opposite a primary lift arm, implement interface, or another workgroup component.

Generally, object detection systems for power machines can provide additional information to an operator of the power machine to improve the operation thereof. For example, object detection equipment can alert an operator to one or more objects that may be in the path of the power machine, and can thereby potentially provide the operator with additional time to alter the travel of the power machine or stop the power machine completely prior to making contact with the object. Further, object detection systems can generally assist in automatic (e.g., autonomous) travel operations, including to help guide automatic travel of a power machine across terrain.

In some examples, improved placement of object detection sensors or other components of object detection systems can result in substantially improved performance, including for automatic travel. For example, power machines often include lift arms, associated (or other) implement interfaces, or other workgroup components for digging, grading, loading, and other operations, with a conventional primary direction of travel that extends in the same direction as the lift arms, etc. (e.g., to the front of a loader with a lift arm and a rigidly supported, forward-facing operator station). In these and other cases, object detection devices that are located on the same side of the power machine as the lift arms, implement interfaces, or other workgroup components, or that are otherwise arranged to monitor for objects on that same side of the power machine, can exhibit somewhat limited ranges or confidence levels for detection of objects, including due to the intervening presence of the lift arms, etc.

Accordingly, in some examples, one or more object detection sensors or other components of an object detection system can be arranged to monitor for the presence of objects in a direction that is opposite a lift arm, implement interface, or other workgroup component of a power machine (e.g., a direction that is opposite a primary lift arm structure or implement interface for a loader). Thus, for example, objects may be detected by the object detection system without substantial interference from the lift arm, implement interface, or other workgroup component, such that ranges and confidence levels for object detection may be maintained at a relatively high level. Correspondingly, in some examples, a primary direction for automatic travel for a power machine may be a direction that is opposite a lift arm, implement interface, or other workgroup component (e.g., opposite a primary lift arm structure for a loader). In some cases, this may correspond to backward travel relative to an operator station of the power machine.

In some examples, an object detection system can include at least one object detection sensor that defines a detection zone (i.e., a volume within a field of view (FOV) of the object detection sensor in which the probability of object detection is of suitable confidence to inform detection of objects). In some examples, an axis of a detection zone (e.g., a central axis of an elliptical detection cone) can be angled obliquely outwardly relative to a relevant path of travel (e.g., a rearward-directed primary path of automatic travel). In some examples, an axis of a detection zone can be angled obliquely upwardly relative to level ground, including so that a lower boundary of the detection zone is substantially parallel to the level ground (i.e., is within ±5 degrees of parallel) at an optimal height (e.g., about 20 to about 30 inches).

As generally noted above, automatic travel of a power machine, as well as other automatic operations, can sometimes be controlled based on objects detected by an object detection system. In some examples, a control device can be configured to alter the velocity of a power machine or to provide an alert to an operator of the power machine, based on detection of an object within a detection zone. For example, depending on the location of an object within a detection zone, relative to the path of travel and the power machine, a control device can be configured to reduce speed for a power machine (e.g., fully stop movement of the power machine along the path of travel) or to provide an audio, visual, or tactile feedback to an operator. In some examples, detection of an object along a path of travel can result in automatic operation of the power machine in an object-detected mode, which can correspond to reductions in velocity, control of steering, or other automatically controlled operations.

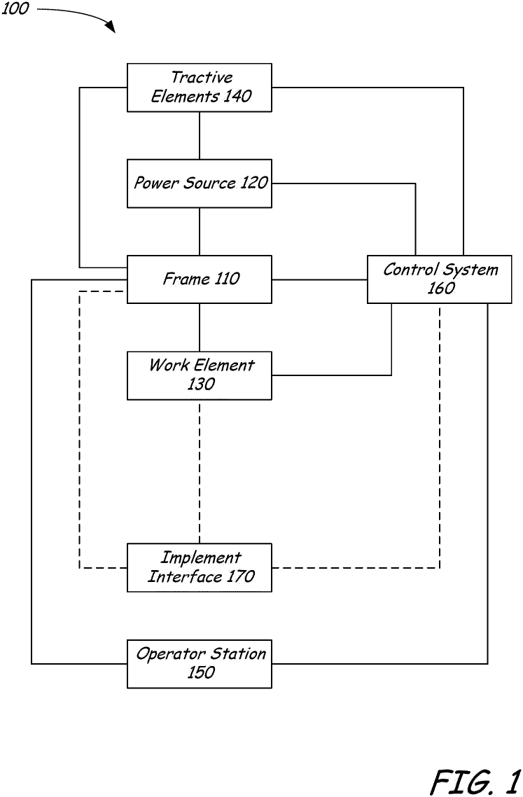

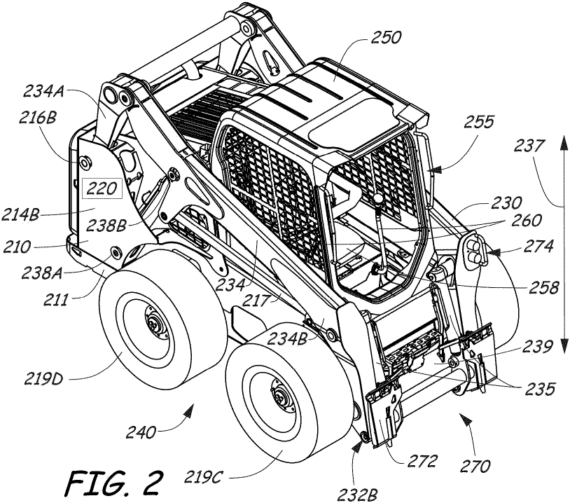

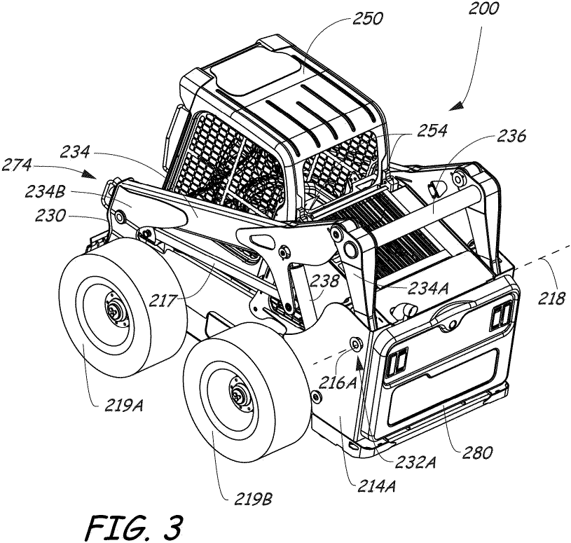

These concepts can be practiced on various power machines, as will be described below. A representative power machine on which the disclosed technology can be practiced is illustrated in diagram form in FIG. 1 and one example of such a power machine is illustrated in FIGS. 2-3 and described below before certain examples are disclosed. For the sake of brevity, only one power machine is illustrated and discussed as being a representative power machine. However, as mentioned above, the examples below can be practiced on any of a number of power machines, including power machines of different types from the representative power machine shown in FIGS. 2-3. Power machines, for the purposes of this discussion, include a frame, at least one work element, and a power source that can provide power to the work element to accomplish a work task. One type of power machine is a self-propelled work vehicle. Self-propelled work vehicles are a class of power machines that include a frame, work element, and a power source that can provide power to the work element. At least one of the work elements is a motive system for moving the power machine under power.

FIG. 1 is a block diagram that illustrates the basic systems of a power machine 100, which can be any of a number of different types of power machines, upon which the examples discussed below can be advantageously incorporated. The block diagram of FIG. 1 identifies various systems on power machine 100 and the relationship between various components and systems. As mentioned above, at the most basic level, power machines for the purposes of this discussion include a frame, a power source, and a work element. The power machine 100 has a frame 110, a power source 120, and a work element 130. Because power machine 100 shown in FIG. 1 is a self-propelled work vehicle, it also has tractive elements 140, which are themselves work elements provided to move the power machine over a support surface and an operator station 150 that provides an operating position for controlling the work elements of the power machine. A control system 160 is provided to interact with the other systems to perform various work tasks at least in part in response to control signals provided by an operator.

Certain work vehicles have work elements that can perform a dedicated task. For example, some work vehicles have a lift arm to which an implement such as a bucket is attached such as by a pinning arrangement. The work element, i.e., the lift arm can be manipulated to position the implement to perform the task. The implement, in some instances can be positioned relative to the work element, such as by rotating a bucket relative to a lift arm, to further position the implement. Under normal operation of such a work vehicle, the bucket is intended to be attached and under use. Such work vehicles may be able to accept other implements by disassembling the implement/work element combination and reassembling another implement in place of the original bucket. Other work vehicles, however, are intended to be used with a wide variety of implements and have an implement interface such as implement interface 170 shown in FIG. 1. At its most basic, implement interface 170 is a connection mechanism between the frame 110 or a work element 130 and an implement, which can be as simple as a connection point for attaching an implement directly to the frame 110 or a work element 130 or more complex, as discussed below.

On some power machines, implement interface 170 can include an implement carrier, which is a physical structure movably attached to a work element. The implement carrier has engagement features and locking features to accept and secure any of a number of different implements to the work element. One characteristic of such an implement carrier is that once an implement is attached to it, it is fixed to the implement (i.e. not movable with respect to the implement) and when the implement carrier is moved with respect to the work element, the implement moves with the implement carrier. The term implement carrier as used herein is not merely a pivotal connection point, but rather a dedicated device specifically intended to accept and be secured to various different implements. The implement carrier itself is mountable to a work element 130 such as a lift arm or the frame 110. Implement interface 170 can also include one or more power sources for providing power to one or more work elements on an implement. Some power machines can have a plurality of work element with implement interfaces, each of which may, but need not, have an implement carrier for receiving implements. Some other power machines can have a work element with a plurality of implement interfaces so that a single work element can accept a plurality of implements simultaneously. Each of these implement interfaces can, but need not, have an implement carrier.

Frame 110 includes a physical structure that can support various other components that are attached thereto or positioned thereon. The frame 110 can include any number of individual components. Some power machines have frames that are rigid. That is, no part of the frame is movable with respect to another part of the frame. Other power machines have at least one portion that can move with respect to another portion of the frame. For example, excavators can have an upper frame portion that rotates with respect to a lower frame portion. Other work vehicles have articulated frames such that one portion of the frame pivots with respect to another portion for accomplishing steering functions.

Frame 110 supports the power source 120, which is configured to provide power to one or more work elements 130 including the one or more tractive elements 140, as well as, in some instances, providing power for use by an attached implement via implement interface 170. Power from the power source 120 can be provided directly to any of the work elements 130, tractive elements 140, and implement interfaces 170. Alternatively, power from the power source 120 can be provided to a control system 160, which in turn selectively provides power to the elements that capable of using it to perform a work function. Power sources for power machines typically include an engine such as an internal combustion engine and a power conversion system such as a mechanical transmission or a hydraulic system that is configured to convert the output from an engine into a form of power that is usable by a work element. Other types of power sources can be incorporated into power machines, including electrical sources or a combination of power sources, known generally as hybrid power sources.

FIG. 1 shows a single work element designated as work element 130, but various power machines can have any number of work elements. Work elements are typically attached to the frame of the power machine and movable with respect to the frame when performing a work task. For example, the power machine can be a mower with a mower deck or other mower component as a work element, which may be movable with respect to the frame of the mower. In addition, tractive elements 140 are a special case of work element in that their work function is generally to move the power machine 100 over a support surface. Tractive elements 140 are shown separate from the work element 130 because many power machines have additional work elements besides tractive elements, although that is not always the case. Power machines can have any number of tractive elements, some or all of which can receive power from the power source 120 to propel the power machine 100. Tractive elements can be, for example, track assemblies, wheels attached to an axle, and the like. Tractive elements can be mounted to the frame such that movement of the tractive element is limited to rotation about an axle (so that steering is accomplished by a skidding action) or, alternatively, pivotally mounted to the frame to accomplish steering by pivoting the tractive element with respect to the frame.

Power machine 100 includes an operator station 150 that includes an operating position from which an operator can control operation of the power machine. In some power machines, the operator station 150 is defined by an enclosed or partially enclosed cab. Some power machines on which the disclosed examples may be practiced may not have a cab or an operator compartment of the type described above. For example, a walk behind loader may not have a cab or an operator compartment, but rather an operating position that serves as an operator station from which the power machine is properly operated. More broadly, power machines other than work vehicles may have operator stations that are not necessarily similar to the operating positions and operator compartments referenced above. Further, some power machines such as power machine 100 and others, whether or not they have operator compartments or operator positions, may be capable of being operated remotely (i.e., from a remotely located operator station) instead of or in addition to an operator station adjacent or on the power machine. This can include applications where at least some of the operator controlled functions of the power machine can be operated from an operating position associated with an implement that is coupled to the power machine. Alternatively, with some power machines, a remote-control device can be provided (i.e., remote from both of the power machine and any implement to which is it coupled) that is capable of controlling at least some of the operator controlled functions on the power machine.

FIGS. 2-3 illustrate a loader 200, which is one particular example of a power machine of the type illustrated in FIG. 1 where the examples discussed below can be advantageously employed. Loader 200 is a skid-steer loader, which is a loader that has tractive elements (in this case, four wheels) that are mounted to the frame of the loader via rigid axles. Here the phrase “rigid axles” refers to the fact that the skid-steer loader 200 does not have any tractive elements that can be rotated or steered to help the loader accomplish a turn. Instead, a skid-steer loader has a drive system that independently powers one or more tractive elements on each side of the loader so that by providing differing tractive signals to each side, the machine will tend to skid over a support surface. These varying signals can even include powering tractive element(s) on one side of the loader to move the loader in a forward direction and powering tractive element(s) on another side of the loader to mode the loader in a reverse direction so that the loader will turn about a radius centered within the footprint of the loader itself. The term “skid-steer” has traditionally referred to loaders that have skid steering as described above with wheels as tractive elements. However, it should be noted that many track loaders also accomplish turns via skidding and are technically skid-steer loaders, even though they do not have wheels. For the purposes of this discussion, unless noted otherwise, the term skid-steer should not be seen as limiting the scope of the discussion to those loaders with wheels as tractive elements.

Loader 200 is one particular example of the power machine 100 illustrated broadly in FIG. 1 and discussed above. To that end, features of loader 200 described below include reference numbers that are generally similar to those used in FIG. 1. For example, loader 200 is described as having a frame 210, just as power machine 100 has a frame 110. Skid-steer loader 200 is described herein to provide a reference for understanding one environment on which the examples described below related to track assemblies and mounting elements for mounting the track assemblies to a power machine may be practiced. The loader 200 should not be considered limiting especially as to the description of features that loader 200 may have described herein that are not essential to the disclosed examples and thus may or may not be included in power machines other than loader 200 upon which the examples disclosed below may be advantageously practiced. Unless specifically noted otherwise, examples disclosed below can be practiced on a variety of power machines, with the loader 200 being only one of those power machines. For example, some or all of the concepts discussed below can be practiced on many other types of work vehicles such as various other loaders, excavators, trenchers, and dozers, to name but a few examples.

Loader 200 includes frame 210 that supports a power system 220, the power system being capable of generating or otherwise providing power for operating various functions on the power machine. Power system 220 is shown in block diagram form, but is located within the frame 210. Frame 210 also supports a work element in the form of a lift arm assembly 230 that is powered by the power system 220 and that can perform various work tasks. As loader 200 is a work vehicle, frame 210 also supports a traction system 240, which is also powered by power system 220 and can propel the power machine over a support surface. The lift arm assembly 230 in turn supports an implement interface 270, which includes an implement carrier 272 that can receive and secure various implements to the loader 200 for performing various work tasks and power couplers 274, to which an implement can be coupled for selectively providing power to an implement that might be connected to the loader. Power couplers 274 can provide sources of hydraulic or electric power or both. The loader 200 includes a cab 250 that defines an operator station 255 from which an operator can manipulate various control devices 260 to cause the power machine to perform various work functions. Cab 250 can be pivoted back about an axis that extends through mounts 254 to provide access to power system components as needed for maintenance and repair.

The operator station 255 includes an operator seat 258 and a plurality of operation input devices, including control levers 260 that an operator can manipulate to control various machine functions. Operator input devices can include buttons, switches, levers, sliders, pedals and the like that can be stand-alone devices such as hand operated levers or foot pedals or incorporated into hand grips or display panels, including programmable input devices. Actuation of operator input devices can generate signals in the form of electrical signals, hydraulic signals, and/or mechanical signals. Signals generated in response to operator input devices are provided to various components on the power machine for controlling various functions on the power machine. Among the functions that are controlled via operator input devices on power machine 200 include control of the tractive elements 219, the lift arm assembly 230, the implement carrier 272, and providing signals to any implement that may be operably coupled to the implement.

Loaders can include human-machine interfaces including display devices that are provided in the cab 250 to give indications of information relatable to the operation of the power machines in a form that can be sensed by an operator, such as, for example audible and/or visual indications. Audible indications can be made in the form of buzzers, bells, and the like or via verbal communication. Visual indications can be made in the form of graphs, lights, icons, gauges, alphanumeric characters, and the like. Displays can be dedicated to providing dedicated indications, such as warning lights or gauges, or dynamic to provide programmable information, including programmable display devices such as monitors of various sizes and capabilities. Display devices can provide diagnostic information, troubleshooting information, instructional information, and various other types of information that assists an operator with operation of the power machine or an implement coupled to the power machine. Other information that may be useful for an operator can also be provided. Other power machines, such walk behind loaders may not have a cab nor an operator compartment, nor a seat. The operator position on such loaders is generally defined relative to a position where an operator is best suited to manipulate operator input devices.

Various power machines that can include and/or interacting with the examples discussed below can have various different frame components that support various work elements. The elements of frame 210 discussed herein are provided for illustrative purposes and frame 210 is not the only type of frame that a power machine on which the examples can be practiced can employ. Frame 210 of loader 200 includes an undercarriage or lower portion 211 of the frame and a mainframe or upper portion 212 of the frame that is supported by the undercarriage. The mainframe 212 of loader 200, in some examples is attached to the undercarriage 211 such as with fasteners or by welding the undercarriage to the mainframe. Alternatively, the mainframe and undercarriage can be integrally formed. Mainframe 212 includes a pair of upright portions 214A and 214B located on either side and toward the rear of the mainframe that support lift arm assembly 230 and to which the lift arm assembly 230 is pivotally attached. The lift arm assembly 230 is illustratively pinned to each of the upright portions 214A and 214B. The combination of mounting features on the upright portions 214A and 214B and the lift arm assembly 230 and mounting hardware (including pins used to pin the lift arm assembly to the mainframe 212) are collectively referred to as joints 216A and 216B (one is located on each of the upright portions 214) for the purposes of this discussion. Joints 216A and 216B are aligned along an axis 218 so that the lift arm assembly is capable of pivoting, as discussed below, with respect to the frame 210 about axis 218. Other power machines may not include upright portions on either side of the frame or may not have a lift arm assembly that is mountable to upright portions on either side and toward the rear of the frame. For example, some power machines may have a single arm, mounted to a single side of the power machine or to a front or rear end of the power machine. Other machines can have a plurality of work elements, including a plurality of lift arms, each of which is mounted to the machine in its own configuration. Frame 210 also supports a pair of tractive elements in the form of wheels 219A-D on either side of the loader 200.

The lift arm assembly 230 shown in FIGS. 2-3 is one example of many different types of lift arm assemblies that can be attached to a power machine such as loader 200 or other power machines on which examples of the present discussion can be practiced. The lift arm assembly 230 is what is known as a vertical lift arm, meaning that the lift arm assembly 230 is moveable (i.e., the lift arm assembly can be raised and lowered) under control of the loader 200 with respect to the frame 210 along a lift path 237 that forms a generally vertical path. Other lift arm assemblies can have different geometries and can be coupled to the frame of a loader in various ways to provide lift paths that differ from the radial path of lift arm assembly 230. For example, some lift paths on other loaders provide a radial lift path. Other lift arm assemblies can have an extendable or telescoping portion. Other power machines can have a plurality of lift arm assemblies attached to their frames, with each lift arm assembly being independent of the other(s). Unless specifically stated otherwise, none of the inventive concepts set forth in this discussion are limited by the type or number of lift arm assemblies that are coupled to a particular power machine.

The lift arm assembly 230 has a pair of lift arms 234 that are disposed on opposing sides of the frame 210. A first end 232A of each of the lift arms 234 is pivotally coupled to the power machine at joints 216 and a second end 232B of each of the lift arms is positioned forward of the frame 210 when in a lowered position as shown in FIG. 2. Joints 216 are located toward a rear of the loader 200 so that the lift arms extend along the sides of the frame 210. The lift path 237 is defined by the path of travel of the second end 232B of the lift arms 234 as the lift arm assembly 230 is moved between a minimum and maximum height.

Each of the lift arms 234 has a first portion 234A of each lift arm 234 is pivotally coupled to the frame 210 at one of the joints 216 and the second portion 234B extends from its connection to the first portion 234A to the second end 232B of the lift arm assembly 230. The lift arms 234 are each coupled to a cross member 236 that is attached to the first portions 234A. Cross member 236 provides increased structural stability to the lift arm assembly 230. A pair of actuators 238, which on loader 200 are hydraulic cylinders configured to receive pressurized fluid from power system 220, are pivotally coupled to both the frame 210 and the lift arms 234 at pivotable joints 238A and 238B, respectively, on either side of the loader 200. The actuators 238 are sometimes referred to individually and collectively as lift cylinders. Actuation (i.e., extension and retraction) of the actuators 238 cause the lift arm assembly 230 to pivot about joints 216 and thereby be raised and lowered along a fixed path illustrated by arrow 237. Each of a pair of control links 217 are pivotally mounted to the frame 210 and one of the lift arms 232 on either side of the frame 210. The control links 217 help to define the fixed lift path of the lift arm assembly 230.

Some lift arms, most notably lift arms on excavators but also possible on loaders, may have portions that are controllable to pivot with respect to another segment instead of moving in concert (i.e., along a pre-determined path) as is the case in the lift arm assembly 230 shown in FIG. 2. Some power machines have lift arm assemblies with a single lift arm, such as is known in excavators or even some loaders and other power machines. Other power machines can have a plurality of lift arm assemblies, each being independent of the other(s).

An implement interface 270 is provided proximal to a second end 232B of the lift arm assembly 234. The implement interface 270 includes an implement carrier 272 that is capable of accepting and securing a variety of different implements to the lift arm 230. Such implements have a complementary machine interface that is configured to be engaged with the implement carrier 272. The implement carrier 272 is pivotally mounted at the second end 232B of the arm 234. Implement carrier actuators 235 are operably coupled the lift arm assembly 230 and the implement carrier 272 and are operable to rotate the implement carrier with respect to the lift arm assembly. Implement carrier actuators 235 are illustratively hydraulic cylinders and often known as tilt cylinders.

By having an implement carrier capable of being attached to a plurality of different implements, changing from one implement to another can be accomplished with relative ease. For example, machines with implement carriers can provide an actuator between the implement carrier and the lift arm assembly, so that removing or attaching an implement does not involve removing or attaching an actuator from the implement or removing or attaching the implement from the lift arm assembly. The implement carrier 272 provides a mounting structure for easily attaching an implement to the lift arm (or other portion of a power machine) that a lift arm assembly without an implement carrier does not have.

Some power machines can have implements or implement like devices attached to it such as by being pinned to a lift arm with a tilt actuator also coupled directly to the implement or implement type structure. A common example of such an implement that is rotatably pinned to a lift arm is a bucket, with one or more tilt cylinders being attached to a bracket that is fixed directly onto the bucket such as by welding or with fasteners. Such a power machine does not have an implement carrier, but rather has a direct connection between a lift arm and an implement.

The implement interface 270 also includes an implement power source 274 available for connection to an implement on the lift arm assembly 230. The implement power source 274 includes pressurized hydraulic fluid port to which an implement can be removably coupled. The pressurized hydraulic fluid port selectively provides pressurized hydraulic fluid for powering one or more functions or actuators on an implement. The implement power source can also include an electrical power source for powering electrical actuators and/or an electronic controller on an implement. The implement power source 274 also exemplarily includes electrical conduits that are in communication with a data bus on the excavator 200 to allow communication between a controller on an implement and electronic devices on the loader 200.

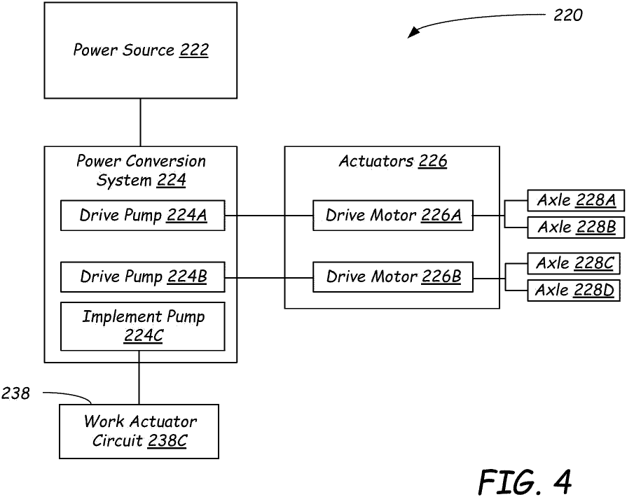

Frame 210 supports and generally encloses the power system 220 so that the various components of the power system 220 are not visible in FIGS. 2-3. FIG. 4 includes, among other things, a diagram of various components of the power system 220. Power system 220 includes one or more power sources 222 that are capable of generating and/or storing power for use on various machine functions. On power machine 200, the power system 220 includes an internal combustion engine. Other power machines can include electric generators, rechargeable batteries, various other power sources or any combination of power sources that can provide power for given power machine components. The power system 220 also includes a power conversion system 224, which is operably coupled to the power source 222. Power conversion system 224 is, in turn, coupled to one or more actuators 226, which can perform a function on the power machine. Power conversion systems in various power machines can include various components, including mechanical transmissions, hydraulic systems, and the like. The power conversion system 224 of power machine 200 includes a pair of hydrostatic drive pumps 224A and 224B, which are selectively controllable to provide a power signal to drive motors 226A and 226B. The drive motors 226A and 226B in turn are each operably coupled to axles, with drive motor 226A being coupled to axles 228A and 228B and drive motor 226B being coupled to axles 228C and 228D. The axles 228A-D are in turn coupled to tractive elements 219A-D, respectively. The drive pumps 224A and 224B can be mechanically, hydraulic, and/or electrically coupled to operator input devices to receive actuation signals for controlling the drive pumps.

The arrangement of drive pumps, motors, and axles in power machine 200 is but one example of an arrangement of these components. As discussed above, power machine 200 is a skid-steer loader and thus tractive elements on each side of the power machine are controlled together via the output of a single hydraulic pump, either through a single drive motor as in power machine 200 or with individual drive motors. Various other configurations and combinations of hydraulic drive pumps and motors can be employed as may be advantageous.

The power conversion system 224 of power machine 200 also includes a hydraulic implement pump 224C, which is also operably coupled to the power source 222. The hydraulic implement pump 224C is operably coupled to work actuator circuit 238C. Work actuator circuit 238C includes lift cylinders 238 and tilt cylinders 235 as well as control logic to control actuation thereof. The control logic selectively allows, in response to operator inputs, for actuation of the lift cylinders and/or tilt cylinders. In some machines, the work actuator circuit also includes control logic to selectively provide a pressurized hydraulic fluid to an attached implement. The control logic of power machine 200 includes an open center, 3 spool valve in a series arrangement. The spools are arranged to give priority to the lift cylinders, then the tilt cylinders, and then pressurized fluid to an attached implement.

The description of power machine 100 and loader 200 above is provided for illustrative purposes, to provide illustrative environments on which the examples discussed below can be practiced. While the examples discussed can be practiced on a power machine such as is generally described by the power machine 100 shown in the block diagram of FIG. 1 and more particularly on a loader such as track loader 200, unless otherwise noted or recited, the concepts discussed below are not intended to be limited in their application to the environments specifically described above.

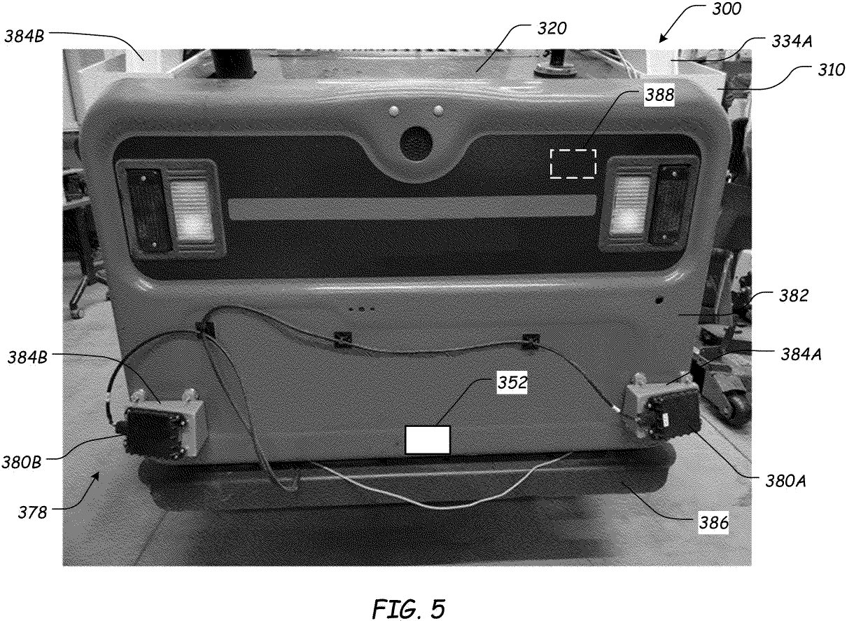

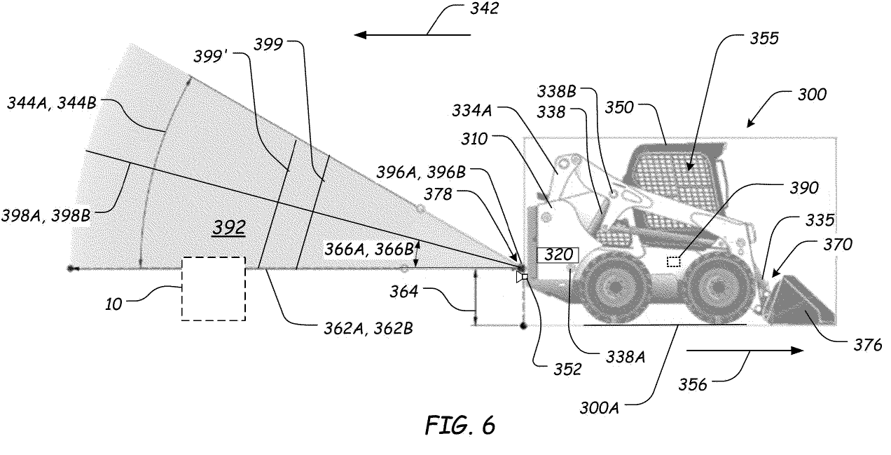

FIGS. 5-7 illustrate a loader 300, which is another particular example of a power machine of the type illustrated in FIG. 1, on which the examples discussed herein can be advantageously employed. Loader 300 is similar in some ways to the loader 200 described above, and like numbers generally represent similar parts. For example, similarly to the loader 200, the loader 300 has a frame 310, and at least one lift arm that is pivotally coupled to an implement interface 370 (here, as above, provided as a set of lift arms 334A, 334B). Moreover, the loader 300 also has a set of actuators 338 that are pivotally coupled to the frame 310 and the lift arms 334A, 334B at pivotable joints 338A and 338B (see FIG. 6), respectively, on either side of the loader 200, 300 (only one side shown in this regard in FIGS. 5-7). The actuators 338 are sometimes referred to individually and collectively as lift cylinders and are shown here as hydraulic cylinders configured to selectively receive pressurized fluid from a power system 320; however, other types of actuators (e.g., electric actuators) are contemplated.

The loader 300 also has a cab, with an enclosed operator station 355 (see FIG. 6) and a set of implement carrier actuators 335 that are pivotally coupled to the lift arms 334 and to the implement interface 370 to allow active tilting of the implement interface 370 (and implements secured thereto, for example a bucket 376 as shown in FIGS. 6 and 7). The lift arms 334A, 334B extend in a first direction 356 away from frame 310 when in a fully lowered configuration (shown in FIGS. 6 and 7), so that an implement attached to the implement interface 370 (e.g., the bucket 376) is disposed to execute work operations spaced apart from the frame 310 in the first direction. The lift arm, implement interface, cab and related components are shown as part of an exemplary embodiment. Other power machines that can incorporate an object detection system may have different types of lift arms, implement interfaces, and cabs, etc.

The loader 300 also includes an object detection system 378. As generally discussed above, object detection systems according to this disclosure generally include at least one object detection sensor that is configured to interoperate with a control device (e.g., a special or general purpose computing device) in order to monitor the environment of a power machine for objects and to control operations of the power machine accordingly. In particular, in the example provided in FIGS. 5-7, the object detection system 378 includes a first object detection sensor 380A and a second object detection sensor 380B. As further discussed below, the object detection sensors 380A, 380B are generally configured to send signals to (and, as applicable, receive signals from) a control device 390, so that signals indicating detected objects can be used to inform automatic (or other) control of the power machine 300.

The first and second object detection sensors 380A, 380B are mounted to the loader 300 (shown in FIG. 5) and are configured to operate with respective detection zones 392A, 392B that extend along a path of travel 342 in a second direction opposite the first direction (as indicated by the arrow in FIGS. 6 and 7). Thus, in the illustrated example, the detection zones 392A, 392B extend in a rearward direction relative to the orientation of lift arms 334A, 334B, the implement interface 370, and the operator station 355 (see FIG. 6). However, in other examples, a detection zone may extend in other directions, including in directions that are opposite an implement interface or other relevant work element (e.g., a primary lift arm), but that are not opposite a forward direction of an operator station (e.g., because no operator station is provided).

In some cases, the detection zones 392A, 392B of the first and second object detection sensors 380A, 380B can be defined as a volume within the respective object detection sensor 380A, 380B FOV in which the object detection sensors 380A, 380B can detect an object with a probability of about 95% and higher. In other cases, detection zones can be otherwise defined, including according to whether a confidence of detection of presence of an object is sufficiently high to be used for control of power machine operations (e.g., as based on manufacturer specifications for a particular object detection sensor).

In some examples, the object detection system 378 can include more or fewer object detection sensors than shown in FIGS. 5-7, including one object detection sensor or more than two object detection sensors. In examples with more than two object detection sensors, the additional object detection sensor(s) can be provided a different height (e.g., relative to the lowest point of the power machine) or may be oriented at a different angle with respect to a path of travel 342. In some examples, the object detection sensors 380A, 380B can be radar sensors, of any of a variety of known types.

In some examples, the FOV of one or both of the object detection sensors 380A, 380B can be in the shape of an elliptical cone, with the detection zones 392A, 392B thus defining a minor angle 344A, 344B (shown in FIG. 6) and a major angle 346A, 346B (shown in FIG. 7) and that extend rearward and outward from apexes 396A, 396B at the object detection sensors 380A, 380B, along and around object detection sensor axes 398A, 398B that extends through the apexes 396A, 396B. Thus, a cross-section of either of the detection zones 392A, 392B at any of a plurality of locations along the object detection sensor axis 398A, 398B defines a corresponding ellipse (e.g. ellipses 399, 399' of FIG. 6), which in turn correspond to lower boundaries 362A, 362B (shown in FIG. 6) and lateral boundaries 368A, 368B (shown in FIG. 7). However, other sensors can operate differently (e.g., as line-scan sensors that scan over particular areas, as sensors with partially-spherical detection zones, etc.).

In examples with a single object detection sensor, for example only the object detection sensor 380A, the detection zone (e.g., the zone 392A) can be shaped similarly to the sensor FOV. However, when more than one object detection sensor is used, for example, both of the object detection sensors 380A, 380B as shown in FIG. 7, a combined detection zone can take many different shapes depending on the lateral and vertical spacing, and the angular orientation, of the object detection sensors. Thus, in some examples, a combined detection zone for a power machine can be larger than a detection zone for a single object detection sensor. For example, a combined detection zone 392 (see FIGS. 6 and 7) is defined by the object detection sensors 380A, 380B for the power machine 300.

The outer boundary of a combined detection zone (e.g., the detection zone 392) can generally be defined by the specifications of the relevant object detection sensors (e.g., the sensors 380A, 380B), including the shape and range of the relevant FOVs, as well as by the mounting orientation (e.g., position and angle) of each of the object detection sensors. Accordingly, a detection zone can be optimized, as appropriate, for the particular characteristics or intended use of a particular power machine, job site, operation profile, etc. For example, as further detailed below, one or more object detection sensors can be arranged to provide a combined detection zone with outer lateral boundaries that extend at particular (e.g., oblique) angles relative to a primary direction of travel of a power machine (e.g., rearward for the power machine 300), with vertical boundaries that extend at particular angles relative level ground (e.g., to be about parallel with the level ground at a lower vertical boundary), or with other characteristics appropriate for a particular task. In this regard, as similarly described above, a placement of object detection sensors to monitor for objects opposite a primary implement interface or other work element (e.g., facing generally rearward relative to an operator station) may be particularly useful, including because this arrangement may maximize an available detection zone without substantial interference from one or more work elements of the power machine.

In some examples, as shown in FIG. 6, the object detection sensors 380A, 380B can be mounted on the loader 300 so that a line extending from the apexes 396A, 396B along the lower boundaries 362A, 362B extends parallel to level ground (e.g., to a plane that is defined by the lowest points of the power machine 300). As shown in FIG. 6, for example, the elliptical cone detection zones 392A, 392B extend from the apex 396A, 396B with a minor angle 344A, 344B. Further, the object detection sensors 380A, 380B are mounted with the respective object detection sensor axes 398A, 398B at a tilt angle 366A, 366B relative to a ground plane 300A of the power machine. In some cases, including as shown in FIG. 6, the tilt angle 366A, 366B of the object detection sensors 380A, 380B can be about half the minor angle 344A, 344B, so that the lower boundaries 362A, 362B of the detection zones 392A, 392B is about parallel to level ground. to achieve this result. In the illustrated example, the tilt angle 366A, 366B is about 15 degrees because the minor angle 344A, 344B is about 30 degrees and the detection zones 392A, 392B are symmetric about the sensor axes 398A, 398B. It should be noted, however, that object detection sensors with smaller or larger minor angles can be arranged similarly, with the tilt angles being about half the minor angle of the object detection sensors, in some cases.

In some examples, orienting one or more object detection sensors to define lower boundaries of detection zones that are substantially parallel to a ground plane (e.g., as described above) can help to reduce the likelihood of detection of objects that do not effectively provide obstacles to power machine operation or to reduce the likelihood of a false detection of the ground itself as a detected object. Further, in some cases, one or more object detection sensors can be oriented so that a lower boundary of the relevant detection zone(s) is located at an optimal height relative to a ground plane. For example, the object detection sensors 380A, 380B can be oriented so that a lower boundary height 364 for the detection zones 392A, 392B (and the combined detection zone 392) can be set to between about 20 and about 30 inches (e.g., at no less than about 25 inches) from the lowest part of the loader 300. Depending on the use case, however, other lower boundary heights can also be set.

In examples in which there is more than one object detection sensor, it may be useful to orient the object detection sensors with particular yaw angles, relative to a direction of a primary path of travel (e.g., a rearward direction for the power machine 300) so as to obtain optimal detection coverage. For example, as illustrated in FIG. 7, the detection zone 392 of the object detection system 378 includes an overlap detection zone 394 created by the overlapping of respective individual detection zones 392A, 392B of the object detection sensors 380A, 380B, with the scope of the overlap partly defined by a yaw angle 367A, 367B of the object detection sensors 380A, 380B relative to the path of travel 342.

In an example arrangement, as shown in FIG. 7, the elliptical cone detection zones 392A, 392B extend from the apexes 396A, 396B with a major angle 346A, 346B of about 120 degrees. Further, the object detection sensors 380A, 380B are oriented with the yaw angles 367A, 367B of the respective object detection sensor axes 398A, 398B of about 15 degrees outward, relative to the path of travel 342. Accordingly, the lateral boundaries 368A, 368B extend outwardly at angles of about 75 degrees relative to the direction of travel 342, in opposite lateral directions, to provide a total coverage in the detection zone 392 of about 150 degrees and an overlap detection zone 394 that extends over a maximum range of about 90 degrees. In some cases, this arrangement can optimally minimize variance in a height a lower boundary of the detection zone 392, due to the curvature of the individual detection zones 392A, 392B, while optimally maximizing the coverage of the detection zone 392 to the sides of the loader 300 and the redundancy of the coverage of the overlap detection zone 394 directly along the path of travel 342. Further, as also discussed below, this arrangement may optimally balance a width of a lateral range of detection (i.e., as defined by the lateral outer boundaries 368A, 368B) with a size of a non-detection zone 348 (i.e., as defined between the lateral inner boundaries 368A, 368B).

In this regard, generally, although the illustrated angular orientations of the object detection sensors 380A, 380B and the ranges (and overlap) of the detection zones 392A, 392B may be particularly suitable for some power machines or work operations, a variety of other configurations are possible. Further, in some cases, one or more object detection sensors can be configured to be dynamically adjusted, including so that an angular range or orientation of a particular object detection sensor can be expanded or contracted depending on a current operation, a current operating profile, a current job site, or other factors.

In some examples, as also generally discussed above, it may be useful for object detection sensors to provide detection zones that extend opposite a lift arm, implement interface, or other primary work element of a power machine. In some cases, accordingly, one or more object detection sensors can be mounted to a power machine opposite a relevant work element (e.g., opposite a lift arm or implement interface), including to structures at a rear side of a particular power machine (e.g., as defined by an attached operator station or primary lift arm).

Referring again to a FIG. 5, for example, the object detection sensors 380A, 380B are illustrated as being mounted on a rear section of the loader 300. In particular, the object detection sensors 380A, 380B are mounted to a movable tailgate 382, although other mounting locations are possible. As shown, each of the object detection sensors 380A, 380B is mounted to the tailgate 382 with a respective external sensor mount 384A, 384B. It is contemplated, however, that the object detection sensors 380A, 380B can be mounted directly to (e.g., can be integrated into) the tailgate 382. Additionally, or alternatively, the object detection sensors 380A, 380B can be mounted to or within a rear bumper 386 of the loader 300 or can be coupled to and extend from the rear bumper 386 or the frame 310. However, in some cases, object detection sensors mounted to tailgate can provide improved orientation of lower boundaries of respective detection zones, including as discussed above relative to FIG. 6 (e.g., due to placement of the object detection sensors at a particular, optimal height).

Generally, orientation of object detection sensors to detect objects in an opposite direction from an implement interface (e.g., on a primary lift arm) can sometimes result in configuration of power machines for travel along primary paths of automatic travel that may be different from primary paths of non-automatic travel. For example, relative to power machines with operator stations that define a front and rear of the power machines, use of object detection sensors and related control systems as disclosed herein can allow for rapid automatic travel (e.g., full-speed automated travel) of the power machines in a rearward direction, thus allowing for effective and rapid navigation relative to obstacles with substantially reduced potential for interference with object detection due to the orientation of a lift arm or other primary work element. Similarly, in other cases, a primary path of travel (e.g., automatic travel) of a power machine that extends opposite a primary work element (e.g., a main lift arm) of the power machine can be enabled by configuration of object detection sensors as disclosed herein.

In some cases, if an object detection sensor is mounted to a movable component, a particular (e.g., different) sensor can be configured to determine an orientation of the movable component to inform appropriate use of data from the object detection sensor. For example, in the implementation shown, in which the object detection sensors 380A, 380B are mounted to the movable tailgate 382, a tailgate position sensor 388 can sometimes be provided. Further, the control device 390 can be configured to execute automatic travel operations based on the tailgate position sensor 388 sensing a current position of the tailgate, as well as based on signals from the object detection sensors 380A, 380B. For example, if the tailgate position sensor 388 senses that the current position of the tailgate is a closed (or locked) position, then the control device 390 can execute automatic travel operations based on signals from the object detection sensors 380A, 380B. However, if the tailgate position sensor 388 senses that the current position of the tailgate is not a closed (or locked) position, the control device 390 can be configured to limit all or some automatic travel operations of the loader 300 (e.g., because the object detection sensors 380A, 380B may not be appropriately oriented to detect obstacles along the path of travel 342 (see FIG. 7)).

Referring again to FIG. 7, in some examples, an object 10 can be detected if any portion of the object 10 enters the detection zone 392. However, in some cases, the geometry of relevant detection zones (e.g., the zones 392A, 392B) can result in a non-detection zone within which the relevant object detection sensors may not reliably detect an object (e.g., the non-detection zone 348). In some cases, therefore, one or more additional sensors can be provided to monitor a non-detection zone for objects. For example, in some examples, the object detection system 378 can further include an ultrasonic sensor 352 (e.g., an ultrasonic transducer of any variety of known configurations) that is mounted to the loader 300 between the object detection sensors 380A, 380B. Thus arranged, the ultrasonic sensor 352 can be configured to detect objects that may be within the non-detection zone 348 and to communicate such a detection to the control device 390, as may then inform control of automatic (or other) power machine operations. In some examples, the detection range of the ultrasonic sensor 352 can overlap at least a portion of the detection zone 392. In some examples, one or more additional radar sensor can be similarly employed.

As also noted above, the object detection system 378 also includes the control device 390, which is generally configured to execute automatic travel (or other) operations for the power machine based on signals from the object detection sensors 380A, 380B (and, as applicable, from other sensors, including the ultrasonic sensor 352). For example, when the loader 300 is moving or is commanded to move along the path of travel 342 opposite the implement interface 370, the control device 390 can receive signals from the object detection sensors 380A, 380B that indicate the presence of objects 10, 12 (shown in FIGS. 6 and 7) in the detection zone 392 along or near the path of travel 342. The control device 390 can then control operation of the power machine 300, including as further detailed below, based on the detected objects 10, 12. In some cases, for example, after an object is initially detected, the control device 390 can monitor the location (e.g., relative lateral spacing from a projection of a machine centerline along a direction of travel) and the distance of the object from the power machine 300 (e.g., a proximity of the object to the power machine measured along a direction of travel), based on continued receipt of signals from the object detection sensor 380A, 380B and can control automatic travel of the power machine 300 accordingly (e.g., to steer around or otherwise avoid contact with the objects 10, 12). In this regard, the control device 390 can generally be included as part of a control system that is configured to control the velocity of the loader 300, including through known approaches to control velocity (i.e., speed and direction) or other travel parameters of power machines.

In some examples, control of power machine travel based on detected objects can include selective operation of a power machine (e.g., the loader 300) in any one of a plurality of operating modes. One example operating mode can include a mode in which the control device 390 sets a maximum allowed power machine speed that is less than a maximum possible power machine speed. Thus, for example, upon detection of a particular object, the control device 390 can effectively de-rate a top speed of a power machine to provide for more finely controlled travel relative to the detected object, or can otherwise modify operator input commands to reduce corresponding tractive actuator commands. In some cases, alteration of the speed of a power machine can be non-linear relative to changes in distance between the power machine and one or more of the detected objects. For example, de-rating of speed may increase exponentially as the detected distance of an object from a power machine decreases. As another example, some operating modes can include causing a full stop of the power machine based on detection of a particular object. For example, detection of an object with a particular proximity to a power machine along a path of travel can sometimes result in the control device 390 causing the power machine to stop movement along the path of travel, in some cases despite operator commands to the contrary.

As still another example, another operating mode can include providing one or more of an auditory alert, a visual-display alert, or a tactile alert to an operator of the power machine. In some cases, an alert may be relatively non-specific (e.g., may be a single tone to indicate a proximate object). In some cases, an alert may represent more detailed information. In some cases, a visual display for an operator may specifically or generally indicate a location of a detected object relative to a power machine (e.g., on a two-axis display), or may specifically or generally indicate a proximity of a detected object to a power machine.

Different display modules can be used in different examples. For example, an object detection display can include a first (e.g., vertical) set of light emitting diodes (LEDs) and a second (e.g., horizontal) set of LEDs. The first set of LEDs can represent a distance an object along a path of travel with respect to a power machine (e.g., a distance rearward of the loader 300). For example, objects that are within a detection zone (e.g., the zone 392) and farther from the power machine can be indicated by LEDs toward the bottom of the vertical set of LEDs and objects that are within a detection zone and closer to the power machine can be indicated by LEDs toward the top of the vertical set. In contrast, the second set of LEDs can represent a lateral location of the object perpendicularly to the path of travel (e.g., to the right or left hand side of the loader 300). For example, objects within a detection zone (e.g., the zone 392) and closer to lateral outer boundaries thereof can be indicated by LEDs toward the outer end of the horizontal set of LEDs and objects within a detection zone and closer to the path of travel can be indicated by LEDs toward the center of the horizontal set of LEDs. In some examples, an object detection display can be integrated into a visual display of a power machine (e.g., a touchscreen of the loader 300) that is used to display other power machine information.

In some examples, an object detection display can be a separate (e.g., standalone) display, including, for example, a display integrated or connected to a window or door in the cab. Such a display can include a screen and/or various lights and indicators. Similarly, an audible indicator can be provided (such as a buzzer or the like) to draw an operator’s attention to the display. In some examples, including as further discussed below, a display module can be installed as part of installation of a retrofit kit for object detection (e.g., mechanically secured as a display device in an operator station, or installed as an update to software for an already-installed display system).

In some examples, a control system can be further configured to control travel of a power machine based on at least temporarily monitoring an object only passively (i.e., by at least temporarily monitoring an object location or distance, but not actively controlling one or more power machine operations on that basis). In some examples, passive monitoring can be implemented based on operator input or based on an operating characteristic of a power machine (e.g., a power machine speed). For example, if an operator input commands movement of the loader 300 away from a detected object (e.g., the object 12 in FIG. 7), the control device 390 may continue to monitor the object, but may not provide audible, visual, or tactile feedback, may not de-rate power machine velocity, or may not otherwise modify power machine operations based on the detected object. As another example, if the loader 300 is traveling below a threshold speed (e.g., about 10% of the maximum speed or 25% of the maximum speed of the loader 300) or transitions to travel below a threshold speed after an object is detected, it may be determined that an operator is likely aware of a detected object and is carefully maneuvering the loader 300 accordingly. Thus, in some cases, alerts or other controls may also be modulated (e.g., temporarily ceased) accordingly.

In some examples, operation of object detection systems can be otherwise modified based on operator input. For example, in some cases, the range of object detection for one or more object detectors can be modified based on operator input. Referring again to FIGS. 6 and 7, for example, operator input may sometimes be received to modify the boundaries of the detection zone 392, including the lower boundaries 362A, 362B and the lateral boundaries 368A, 368B, or to otherwise modify operation of the object detection sensors 380A, 380B or the interoperation of the sensors 380A, 380B and the control device 390. In some cases, operator input may similarly modify orientation of one or more object detection sensors, including directly (e.g., via manipulation of a control interface) or indirectly (e.g., via automatic reorientation of an object detection sensor based on a particular commanded operation of a power machine)

In some examples, selection of an operating mode can be made via a button or a plurality of buttons on a joystick (e.g., a button (not shown) on the control levers 260 of FIG. 2) or through a graphic user interface in a display (not shown). In some examples, an object detection system can present an operator with an option to select an operating mode from a predetermined set of operating modes, or to customize a selected (or other) operating mode. In some examples, operating modes can be automatically implemented, including based on operating profiles, based on characteristics of particular power machines, work operations, or job sites, or based on other factors.

In some examples, upon detection of an object, one of a plurality of selectable operating modes can slow a power machine to a stop at a predetermined (e.g., default) deceleration rate or over a predetermined (e.g., default) stopping distance. Another of the selectable operating modes can slow a power machine down but not automatically stop the power machine based upon detecting an object. In both of these modes, it is contemplated that various deceleration rates can be used, including as a result of an operator selecting a deceleration rate, and stopping distances can be similarly varied as applicable. For example, a deceleration rate can be selected from a predetermined number (e.g., two) of operator-selectable deceleration profiles or otherwise customized based on operator input or other factors. Similarly, for example, an operator can customize a minimum stopping distance, including by selecting from a set of predetermined minimum stopping distances (e.g., 2.5 feet, 10 feet, 12 feet, or 15 feet, and other values in this range).

In some examples, one of a plurality of selectable operating modes can cause a power machine to issue an alert upon detection of an object, including, for example, an auditory alert, a visual-display alert, or a tactile alert, as discussed previously, to be activated when an object is detected in the path of travel of the power machine. An alert can generally be provided as a standalone feature, including as a main (e.g., only) response to a detected object in some operational modes. In some examples, an alert can be provided as part of selectable operating modes that also include other functionality, including for slowing or stopping a power machine as discussed above. In some examples, an operating mode with an alert can be implemented on a mechanically controlled power machine, in which mechanical control of the power machine (e.g., via cables, mechanical actuation of a pilot valve for pilot-operated hydraulic controls, or a mechanical linkage between a joystick and a pump), may preclude certain kinds of automatic control. Generally, any of the object detection systems, modes, and features described herein can assist in automatic (e.g., autonomous or semi-autonomous) travel operations, as discussed above, and in power machines that are fully human operated.

In some implementations, devices or systems disclosed herein can be utilized or installed using methods embodying aspects of the disclosed technology. Correspondingly, description herein of particular features or capabilities of a device or system is generally intended to inherently include disclosure of a method of using such features for intended purposes and of implementing such capabilities. Similarly, express discussion of any method of using a particular device or system, unless otherwise indicated or limited, is intended to inherently include disclosure, as examples of the disclosed technology, of the utilized features and implemented capabilities of such device or system.

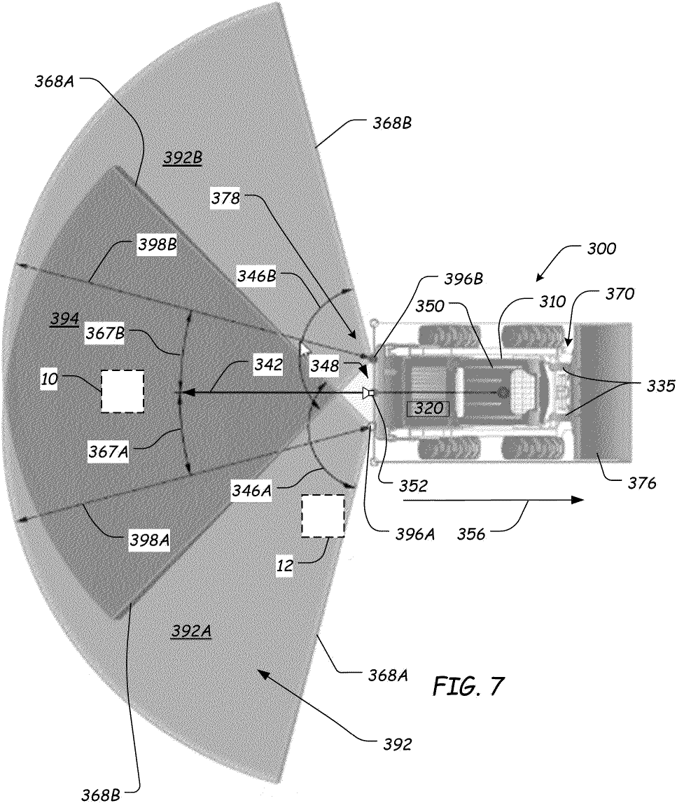

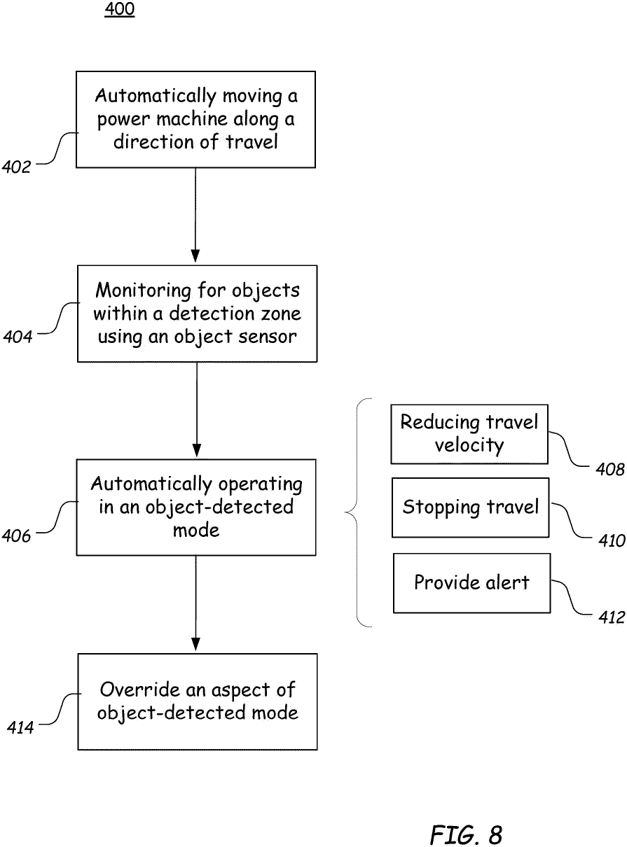

In this regard, for example, FIG. 8 illustrates an example method 400 for controlling a power machine (e.g., the loader 300) with an implement interface. At block 402, the method 400 can include automatically moving the power machine along a direction of travel. In some cases, as also discussed above, the block 402 can include automatically moving a power machine in a direction that is opposite the implement interface (or opposite a lift arm or other primary work element).

At block 404, the method 400 can include using an object detection sensor (e.g., a radar device) to monitor for objects as the power machine moves in the direction of travel ― or at other times, as appropriate (e.g., before operations at the block 402 for automatic travel). In some cases, also as discussed above, a relevant object detection sensor can be oriented to primarily detect objects in a primary direction of travel. In some cases, a primary direction of automatic travel may be different from a primary direction of non-automatic travel or from a primary direction for execution of work operations. For example, as generally discussed above relative to the loader 300 (see FIGS. 5-7), radar sensors can sometimes be used to enable travel at full rated speed for a power machine in a rearward direction relative to an operator station, or otherwise in a direction that is opposite a primary work element (e.g. an implement interface on a primary lift arm).

At block 406, the method 400 can further include, if an object is detected in the detection zone, automatically operating the power machine in an object-detected mode. In some cases, operations under the block 406 can thus include automatically controlling travel of a power machine along the direction of travel based on further monitoring of the object using the object detection sensor. For example, as also discussed above, a location of an object or a distance of an object from a power machine can be monitored based on signals from one or more object detection sensors and controlling travel speed or other operations of a power machine accordingly. Thus, for example, the method 400 can include automatically reducing a travel velocity of the power machine based on the detected object (see block 408), automatically stopping the power machine based on the detected object (see block 410), or providing a relevant alert (see block 412).

In some cases, at block 414, the method 400 can further include overriding one or more aspects of an object-detected mode. For example, as also discussed above, a required reduction in travel speed can sometimes be overridden if an actual travel speed or a commanded travel speed of the power machine is at or below a speed threshold (e.g., 10% of a maximum rated power machine speed), or based on other relevant conditions or inputs.

In some cases, an object detection system can be installed as a kit for a power machine, including as may be used to retrofit a power machine for expanded operational capabilities. For example, some implementations can include a retrofit kit that can operate alongside (or cooperatively with) a pre-existing control system of a power machine to provide expanded object detection capabilities for the power machine.

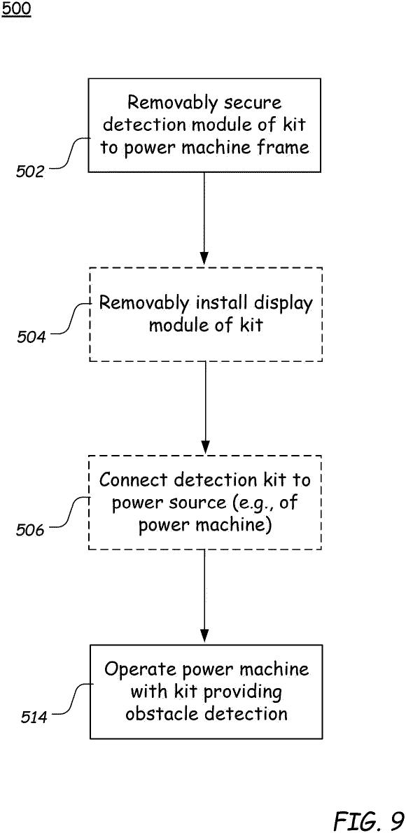

For example, as illustrated in FIG. 9, a method 500 can be executed to install and operate a kit for a power machine (e.g., as a retrofit installation rather than a factory installation) to provide enhanced obstacle detection functionality for the power machine. At block 502, the method can include removably securing a detection module to the power machine. For example, the detection module can be a radar module or other module with known object detection capabilities (e.g., ultrasound, LIDAR, etc.) that can be attached to a tail gate, bumper, or other structure of a power machine so as to be appropriately secured for operation but also to be removable as desired. Thus, for example, a kit secured to a first power machine at block 502 can later be removed from the first power machine and then secured to a second, different power machine (e.g., at block 502 in a subsequent execution of the method 500), so as to provide object detection functionality for the second power machine. In some cases, a single kit (or a small number of kits) can accordingly be used to provide temporary object detection capabilities to select power machines of a large fleet of machines.

In some examples, a detection (or other) module of a kit can be magnetically secured to a power machine. For example, a radar module or other sensor-based object detection module can be temporarily magnetically secured to a tailgate, a bumper, or another structure of a power machine so as to be oriented to detect objects in a relevant detection zone. In some examples, a module of a kit can be instead (or additionally) be secured with other fasteners, including threaded fasteners, hooks, clasps, pins, specialized brackets, etc. Further, although dedicated or preferred locations for a module can be specified in some cases (e.g., with positioning of a radar module according to discussion above), some modules can be configured to be selectively secured at any variety of customized locations on a power machine.

In some cases, securing a detection (or other) module of a kit can include connecting the module to a CAN bus or other integrated communication and control architecture of the power machine. In some cases, securing a module of a kit fo a power machine can include otherwise connecting the module for communication with the power machine (e.g., via a control device of the kit, as further discussed below).

At block 502, a detection module of a kit can generally be secured to a power machine so as to be aligned to detect objects along a direction of travel of the power machine. For example, a radar module can be aligned to detect objects that are primarily rearward, forward, or laterally to either side of a power machine, as appropriate. In some examples, multiple detection modules can be secured to a power machine at block 502 to provide object detection relative to multiple directions (e.g., rearward and forward). A detection module can also generally be installed at block 502 to be in electronic communication with a controller (e.g., a separate component of the kit to be secured to the power machine, or a module of an integrated control system of the power machine).

Any variety of known electronic communication protocols or channels can be used, as appropriate, for communication between a detection module, a controller, and various other components of an object detection kit or power machine. Further, in some examples, the various modules of a detection system as discussed herein can be in direct or indirect electronic communication with external controllers or other external computing devices, including mobile remote control devices and fixed-location remote control servers). For example, a control module for an object detection system can be in communication with a remote control device configured to display indicators of detected objects, or with a remote automatic-control system configured to direct automatic operations of a power machine.

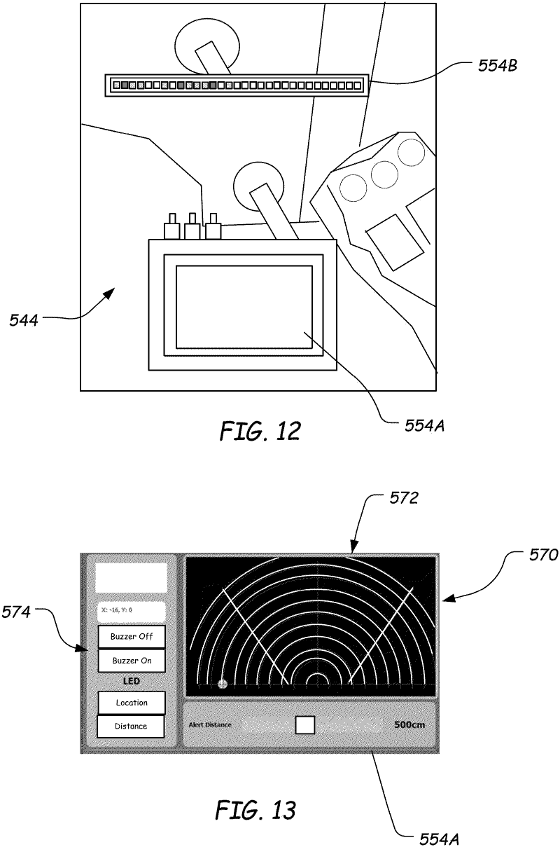

At block 504, the method 500 can include removably installing a display module on the power machine in electronic communication with the detection module or various other electronic systems of the kit or the power machine. In some cases, installing a display module can include securing a display screen or other display device to be viewed by an operator in an operator station of a power machine. For example, using suction mounts that engage a viewing window (see, e.g., FIG. 12) or other known mounting systems, an LCD or other touchscreen display and an LED array can be installed in a cab of a power machine, or otherwise located to be viewable from an operator station of the power machine. In some cases, installing a display module can include installing a software (or other) update for an existing display system of a power machine, including as can provide the existing display system (and associated control system) with the capability of providing particular indicators to an operator corresponding to objects detected by the detection module (e.g., auditory alerts, graphical or light-array visual indicators, etc.).

At block 506, the method 500 can include connecting one or more component of an object detection kit to a power source. In some cases, operations at block 506 can include removably installing a power module to be engaged with a power connection of the power machine. The power module can thereby receive power from a power source of a power machine, so as to power one or more of an associated object detection module, display module, control module, etc. In some cases, a power module can include a connector for temporary engagement with an auxiliary power connector of the relevant power machine (e.g., a socket, plug, or other connector for a 12 volt power source). In some cases, a power module can include or be included in a wiring harness for providing electronic communication between detection, control, and other modules of an object detection kit. In some cases, a power module can be integrated with another component of an object detection kit (e.g., as a battery in a display module, a detection module, etc.).

In some examples, the method 500 can also include installing a control module in communication with a detection module and a display module, so that the control module can control the display module based on signals from the detection module to provide relevant alerts to an operator based on detection of objects by the detection module. In some examples, installing a control module can include installing a software or other update to a control system of the relevant power machine. In some examples, a control module can be provided as a component of a kit to be mechanically installed onto a power machine (e.g., as a standalone control device, or a control device integrated into a temporarily secured detection module or display module).

With a kit installed, the method 500 can include, at block 514, operating the power machine, with the kit providing obstacle detection functionality for the power machine. For example, a radar module temporarily secured to power machine as part of a retrofit kit can interoperate with a similarly installed display module so that an operator can be alerted to one or more detected characteristics of one or more objects during operation of the power machine (e.g., to indicate relative object location or movement of the object relative to the frame of reference of the power machine).

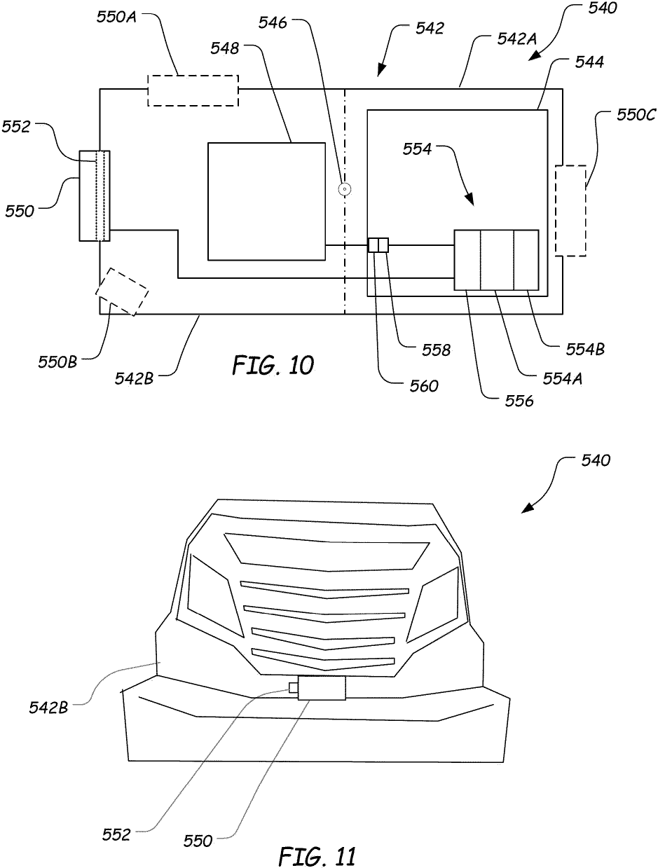

FIG. 10 schematically illustrates components of a power machine with a retrofit kit installed for object detection, including as can be implemented under the method 500 (see above). In particular, a power machine 540 includes a main frame 542, which can be an articulated frame with a front frame 542A that supports an operator station 544 (e.g., an enclosed cab) and pivots about a vertical pivot axis 546 relative to a rear frame 542B that supports a power source 548 (e.g., a battery or other electrical storage system, an internal combustion engine, etc.). In other examples, however, other types of power machines can be similarly equipped (e.g., telehandlers, various non-articulated power machines, or articulated power machines with differently arranged frames).

In the illustrated example, the retrofit kit includes a detection module 550, which can be removably secured to the power machine 540 to detect objects near the power machine 540. As also noted above, a detection module can include one or more sensors of a variety of configurations and in some cases can include a radar system as can detect objects within a detection zone that extends across part of the area that surrounds the power machine. In some examples, a detection module can be magnetically secured by a magnet connector 552 (e.g., a rare earth or other magnet and an associated bracket to secure the magnet to the detection module). In other examples, a module can be otherwise attached, including using brackets, threaded or other non-threaded fasteners, adhesives, etc.

In the illustrated example, the detection module 550 is secured to a rear of the power machine 540 so as to detect objects in a rearward direction. For example, as shown in FIG. 11, the detection module 550 can be secured with the magnet connector 552 to a tailgate or other structure at a rear end of the rear frame of an articulated power machine, including as can provide similar benefits as discussed above. In other examples, however, a detection module can alternatively (or additionally) be secured at other locations or with other orientations. For example, as shown in FIG. 10, a detection module 550A can be secured to a lateral side of the power machine 540 (e.g., still on the rear frame 542B, as shown), a detection module 550B can be secured at a corner (e.g., a rear corner) of the power machine 540, or a detection module 550C can be secured at a front of the power machine 540 (e.g., on the front frame 542A, as shown). In some cases, a single detection module can be configured to be selectively installed at any variety of different locations on a power machine.

Still referring to FIG. 10, a display module 554 can also be removably installed on the power machine 540, including at or within the operator station 544. In some cases, the display module 554 can include multiple sub-modules. For example, as illustrated in FIG. 10, the display module 554 can include a display screen 554A (e.g., a touchscreen equipped with a speaker or other audio output device) and a lighting (e.g., LED) assembly 554B. In other examples, different configurations are possible, including with display modules that include only a screen, only a lighting assembly, etc. In some examples, as also discussed above, an existing display system of a power machine can be employed for an object detection kit. For example, installing a retrofit kit can include installing a software update so that a pre-existing display device of a power machine can provide alerts associated with object detection by the kit.

To coordinate object detection and associated alerts, a control module can be generally arranged in electronic communication with a detection module and a display module. In some examples, a control module can utilize pre-existing control systems of a power machine (e.g., after installation of associated software or firmware updates to configure the control module for object-detection functionality). In some examples, a dedicated control device can be included in a retrofit kit and can be secured to power machine during installation of the kit. For example, as shown in FIG. 10, an electronic controller 556 (e.g., of various generally known types of electronic computers) can be installed on the power machine 540 (e.g., within the operator station 544) to be in electronic communication with the detection module 550 and the display module 554. Thus, the controller 556 can receive signals from the detection module 550 that indicate detected objects, can analyze or otherwise process those signals, and can thereafter control the display module 554 (or other modules) accordingly. As also generally noted above, the controller 556 can be a stand-alone module, or can be integrated into other modules (e.g., either of the modules 550, 554). In some examples, the controller 556 or other modules can be installed to be in direct communication with a CAN bus (not shown) of the power machine 540.

In some examples, a kit for object detection can include a power module, as can ensure that operational power is provided to a detection module, a display module, or a control module, as needed. In some cases, a power module can be configured to provide stand-alone power. For example, a power module can include an integrated battery or other integrated power source for the kit that can provide power independently of the power machine. In some cases, a power module can be configured to connect a kit to a power source of a power machine. For example, as illustrated in FIG. 10, a power module includes a power connector 558 that is configured to be removably connected with a power connector 560 of the power machine, so as to draw power from the power source 548. The power connector 558 can take any variety of known configurations and in some cases can be configured to engage an auxiliary power connector for the power machine 540 (e.g., with the power connector 558 as a standard 12 V plug or other known connector). In some examples, the power connector 558 can be integrated with or otherwise connected to a wiring harness, as can also provide connections for power and electronic communication for (and among) the detection module 550, the display module 554, the control module 556, etc.

Thus, for example, the control module 556 can receive object-detection data (e.g., radar data) from the detection module 550, and can control the display module 554 based on the object-detection data to provide, via the display module 554, one or more indicators of an object detected by the detection module 550 (e.g., as similarly detailed above). In this regard, a display module can provide alerts using various auditory or visual formats to provide operators with useful information about the presence of objects near the power machine 540.

As also noted above, a display module can take a variety of forms. As shown in FIG. 12, for example, the display screen 554A can be configured as a touchscreen device that can display a variety of graphical indicators and emit a variety of auditory indicators for an operator. As shown in FIG. 13, graphical indicators for a display module can include a graphical display 570 that represents a spatial area 572 proximate a power machine (e.g., directly behind the power machine) and can represent locations of detected objects on the area 572 (e.g., in real time) to alert operators to the objects. As a further example, graphical indicators can also include text alerts or other visually discernable representations. As noted above, some indicators can also be auditory (e.g., as provided by speakers or buzzers associated with the display screen 554A).

In some cases, a display module can be configured to receive user input, including as can respond to particular alerts or customize operation of a particular object detection system (e.g., a retrofit kit). As also shown in FIG. 13, the display 570 on the display screen 554A (see also FIG. 12) can include input icons 574 through which a user can adjust an auditory response of the system, or characteristics one or more functions or devices of the display module 554. For example, the display screen 554A is configured in particular to receive inputs for adjusting sound levels of auditory alerts, and for adjusting visual display settings (e.g., for an LED array, as further discussed below).

Referring again to the example configuration of FIG. 12, the lighting assembly 554B is configured as a one-dimensional lighting display (i.e., a display in which light sources are arranged to provide an illumination pattern that varies only in one direction). In the illustrated example, the lighting assembly 554B is a horizontal one-dimensional lighting display and information on detected objects can accordingly be conveyed by variations of a lighting pattern along the horizontal length of the assembly 554B. In other examples, other configurations are possible.

In some cases, a lighting assembly can be configured to provide object-detection information along a one-dimensional array by varying multiple (e.g., two) lighting characteristics along a particular direction. For example, the lighting assembly 554B can be controlled to indicate both position and proximity of multiple detected objects using a one-dimensional LED array. In particular, individual lighting units (e.g., LED dies) of the lighting assembly 554B can be illuminated to spatially indicate detection of objects at particular lateral locations relative to the power machine, and can be illuminated with a particular light type (e.g., a particular brightness or color) to indicate a proximity distance of the relevant particular object(s) to the power machine (i.e., a relative or absolute distance between the object(s) and the power machine along a direct path or a direction of current or primary travel for the power machine). Thus, in the object-detection state illustrated in FIG. 12, illumination of particular LED dies with only a single color (e.g., green) and only toward the left of the lighting assembly 554B indicates that the detection module 550 (see FIG. 11) has detected objects only toward the left side of the power machine and only with a distance to the power machine that is larger an alert threshold (e.g., larger than a minimum distance for an escalated alert as determined by default setting or user input). In contrast, illumination of different LED dies would indicate detection of objects at different locations, and illumination of particular LED dies with different colors would indicate different proximity distances for the particular associated objects. Correspondingly, a combination of colors and locations as shown in FIG. 12 can provide information about locations and distances for multiple detected objects. Thus, for example, an operator can quickly extract useful information about detected objects and power machine travel paths using a relatively simple and non-distracting visual display as provided by the lighting assembly 554B.

In some examples, a user can customize a display module to indicate objects at particular locations in particular ways. For example, discrete lighting sections on a one-dimensional lighting array (e.g., the lighting assembly 554B) can be customizably associated with particular real-world spatial ranges (e.g., so that particular spatial ranges f LEDs correspond to particular real-world spatial ranges), including as can be customized based on size or other characteristics of a relevant power machine, operator, or operation. Similarly, customized thresholds or other criteria can be established (e.g., input by users) for illuminating particular lighting sections with particular types of light. For example, a first light color (e.g., green) can be used for particular lighting sections to indicate that a detected object is relatively far away, and other light colors (e.g., yellow, red, etc.) can be used to indicate that a detected object for a particular lighting section is relatively close to the power machine. Again, these criteria can be customized for particular power machines, operators, or users (e.g., including as may correspond to different modes discussed above), including via operator inputs at the display screen 554A.

In some examples, alerts based on proximity can be provided based on a distance of a detected object from a power machine and based on a travel speed (e.g., present or maximum travel speed) of the power machine. For example, to determine a particular type (e.g., color) of light to be displayed for a particular object by a display module of a power machine, the proximity distance of the object relative to the power machine can be determined and compared to a current travel speed of the power machine or to another reference travel speed (e.g., a maximum rated travel speed in the relevant travel direction). The type of light for the particular object can then be selected accordingly, i.e., based on the scaled proximity distance. This scaling of distance by travel speed can allow operators to be provided with alerts that relate not only to how distant detected objects may be but also to how quickly the objects might approach (or are approaching) the power machine.

Although examples above discuss lateral position (e.g., based on position relative to a centerline of a power machine) and proximity (e.g., based on distance from a power machine along a present direction of travel), indicators based on other criteria are also possible. Further, in some cases, object detection systems can be automatically (or otherwise) update alert parameters based on characteristics of the particular power machines on which the systems are installed. For example, upon installation of an object detection kit on a power machine, communication between the kit and the power machine can inform the object detection kit of a maximum rated speed, lateral width, or other relevant parameter for the power machine, as can inform customized provision of alerts for detected objects. Thus, for example, alerts as to object proximity and lateral location can be appropriately matched to the particular characteristics of a particular power machine, even though a relevant kit can be installed on a wide variety of different power machines (e.g., with a variety of widths and rated top speeds).

In some examples, an object detection system can analyze data that indicates one or more detected objects to determine whether a power machine is traveling toward a particular object, and an alert can be provided (or not provided) to an operator accordingly. For example, upon receiving detection data for a plurality of objects (or object points), a control device can the detection data (e.g., relative to changes over time) to determine a direction of movement of a particular object ― or of detected objects on average ― and thereby determine whether the relevant objects are moving toward or away from a power machine. Correspondingly, a system can sometimes be configured to provide alerts only when a relevant object has been determined to be moving toward the power machine (e.g., for a stationary object, because the power machine is moving toward the object), whereas alerts may not be provided for objects that are close to the power machine but moving farther away. For example, upon determining that a distance between a power machine and a detected object is decreasing, a system can provide a visual or auditory indicator to an operator to alert the operator of this determination. In contrast, if the distance is instead increasing, the system may sometimes not provide such a visual or auditory indicator.

In some examples, aspects of the disclosed technology, including computerized implementations of methods according to the disclosed technology, can be implemented as a system, method, apparatus, or article of manufacture using standard programming or engineering techniques to produce software, firmware, hardware, or any combination thereof to control a processor device (e.g., a serial or parallel general purpose or specialized processor chip, a single-or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, some examples of the disclosed technology can be implemented as a set of instructions, tangibly embodied on a non-transitory computer-readable media, such that a processor device can implement the instructions based upon reading the instructions from the computer-readable media. Some examples of the disclosed technology scan include (or utilize) a control device such as an automation device, a special purpose or general purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.).

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the disclosed technology, or of systems executing those methods, may be represented schematically in the FIGS. or otherwise discussed herein. Unless otherwise specified or limited, representation in the FIGS. of particular operations in particular spatial order may not necessarily require those operations to be executed in a particular sequence corresponding to the particular spatial order. Correspondingly, certain operations represented in the FIGS., or otherwise disclosed herein, can be executed in different orders than are expressly illustrated or described, as appropriate for particular examples of the disclosed technology. Further, in some examples, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” “block,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

Although the present technology has been described by referring preferred examples, workers skilled in the art will recognize that changes may be made in form and detail without departing from the scope of the discussion.

What is claimed is:

1. A power machine comprising:
a main frame;
a lift arm pivotally secured to the main frame, the lift arm extending in a first direction away from main frame in a fully lowered configuration so that an implement interface secured to the lift arm is spaced apart from the main frame in the first direction;
an object detection system that includes an object detection sensor mounted to the power machine; and
a control device configured to execute automatic travel operations for the power machine based on signals from the object detection sensor;
wherein the object detection sensor is configured to monitor a detection zone for objects along a path of automatic travel that extends in a second direction that is opposite the first direction.

2. The power machine of claim 1, wherein the object detection sensor is mounted to a movable tailgate of the power machine.

3. The power machine of claim 2, further comprising:
a tailgate position sensor;
wherein the control device is further configured to execute automatic travel operations based on the tailgate position sensor sensing a current position of the movable tailgate.

4. The power machine of claim 1, wherein the object detection sensor is mounted to a bumper of the power machine.

5. The power machine of claim 1, wherein the detection zone extends from an apex of the detection zone located at the object detection sensor, along and around an object detection sensor axis extending from the apex;
wherein a cross-section of the detection zone at any of a plurality of locations along the object detection sensor axis defines a corresponding shape with a lower boundary; and
wherein the object detection sensor is mounted to the power machine so that, with the power machine on level ground, a line extending from the apex through a plurality of the lower boundaries extends parallel with the level ground.

6. The power machine of claim 5, wherein the detection zone forms an elliptical cone.

7. The power machine of claim 5, wherein, with the power machine on the level ground, the line extending from the apex through the plurality of the lower boundaries is between 20 inches and 30 inches above the level ground.

8. The power machine of claim 1, wherein the object detection sensor is a first object detection sensor defining a first detection zone that extends from a first apex at the first object detection sensor, along and symmetrically around a first axis extending from the first apex;
wherein the power machine further comprises a second object detection sensor mounted to the power machine, the second object detection sensor defining a second detection zone that extends from a second apex at the second object detection sensor, along and symmetrically around a second axis, the second object detection sensor being configured to monitor a second detection zone for objects along the path of automatic travel in the second direction; and
wherein the control device is further configured to execute the automatic travel operations for the power machine based on signals from the second object detection sensor.

9. The power machine of claim 8, wherein the first detection zone overlaps with the second detection zone.

10. The power machine of claim 9, wherein at least one of the first axis or the second axis extends at an oblique angle relative to the path of automatic travel.

11. The power machine of claim 10, wherein the angle is about 15 degrees.

12. The power machine of claim 10, wherein the first and second detection zones collectively define opposed lateral boundaries of the object detection system, the opposed lateral boundaries extending outwardly from the main frame, obliquely to the path of automatic travel.

13. The power machine of claim 1, wherein the object detection sensor includes a radar sensor.

14. The power machine of claim 13, further comprising an ultrasonic sensor configured to detect obstacles in a non-detection zone for the radar sensor.

15. A control system for a power machine, the control system comprising:
an object detection sensor configured to monitor a detection zone for objects along a primary path of travel that extends from the power machine in a first direction that extends opposite a primary implement interface of the power machine; and
a control device configured to execute operations including:
when the power machine is moving or is commanded to move in the first direction, receiving signals from the object detection sensor that indicate detected objects in the detection zone; and
providing an indication of the detected objects to an operator of a power machine.

16. The control system of claim 15, wherein the control device is further configured to control the travel of the power machine along the primary path of travel based on the received signals that indicate the detected objects; and
wherein the control of the travel of the power machine based on the received signals includes selective operation of the power machine in any one of a plurality of operating modes, the plurality of operating modes including at least one of:
a first operating mode that includes, based on the received signals that indicate the detected objects, reducing a current power machine speed relative to a commanded speed or relative to a maximum possible power machine speed; or
a second operating mode that includes, based on the received signals that indicate the detected objects, causing the power machine to stop movement along the primary path of automatic travel.

17. The control system of claim 16, wherein control of the travel of the power machine based on the received signals includes operation in the first operating mode; and
wherein the reduction of the current power machine speed is non-linear relative to changes in distance between the power machine and one or more of the detected objects.

18. The control system of claim 15, wherein the control device is further configured to provide the indication of the detected objects by providing one or more of an auditory alert, a visual-display alert, or a tactile alert to the operator of the power machine, corresponding to at least one of the detected objects.

19. The control system of claim 18, further comprising an object detection display;
wherein the control system is configured to provide the indication of the detected objects to the operator by providing a visual representation on the object detection display of a location and a distance of one or more of the detected objects relative to the power machine.

20. The control system of claim 15, wherein a range of object detection for the object detection sensor is controllable by an operator.

21. A method of controlling a power machine with an implement interface, the method comprising:
automatically moving the power machine along a direction of travel opposite the implement interface;
monitoring for objects within a detection zone with an object detection sensor, the detection zone extending in the direction of travel; and
if an object is detected in the detection zone, as indicated by the object detection sensor, automatically operating the power machine in an object-detected mode, including automatically controlling travel of the power machine along the direction of travel based on further monitoring of the object using the object detection sensor.

22. The method of claim 21, wherein operating the power machine in the object-detected mode includes automatically reducing a travel velocity of the power machine based on the detected object.

23. The method of claim 22, wherein the operating in the object-detected mode includes automatically stopping the power machine based on detecting the detected object.

24. The method of claim 21, wherein operating the power machine in the object-detected mode is overridden based on one or more of an actual travel speed or a commanded travel speed of the power machine being at or below a speed threshold.

25. The method of claim 24, wherein the speed threshold is 25% of a maximum power machine speed.

26. The method of claim 24, wherein the speed threshold is 10% of a maximum power machine speed.

27. A control system for a power machine, the control system comprising:
an object detection sensor configured to monitor a detection zone for objects along a primary path of travel;
a control device configured to execute operations including:
when the power machine is moving or is commanded to move along the primary path of travel, receiving signals from the object detection sensor that indicate detected objects in the detection zone;
selecting an operational mode from among:
a first operational mode configured slow the power machine to a stop when an object is detected in the detection zone;
a second operational mode configured to slow but not stop the power machine when an object is detected in the detection zone; and
a third operational mode configured to provide an alert to an operator of the power machine when an object is detected in the detection zone; and
controlling the power machine during travel along the primary path of travel based on the selected operational mode and the received signals that indicate the detected objects.

28. The control system of claim 27, wherein the control device is further configured to determine, based on operator input, one or more of:
a deceleration profile for the first or second operational modes; or
a minimum stopping distance for the first operational mode.

29. A retrofit kit for a power machine, the kit comprising:
a detection module configured to be removably secured to the power machine to detect objects around the power machine;
a control module configured to be installed in electronic communication with the detection module and a display module; and
a power module configured to be removably engaged with a power connection of the power machine to receive power from a power source of a power machine to power one or more of the detection module or the control module; and
the control module being configured to receive detected object data from the detection module and communicate with the display module based on the detected object data to provide one or more indicators of an object detected by the detection module.

30. The retrofit kit of claim 29, further comprising:
the display module, wherein the display module is configured to be removably installed on the power machine.

31. The retrofit kit of claim 30, wherein the display module includes an LED module configured to provide a plurality of light signals corresponding to a position of the detected object relative to the power machine.

32. The retrofit kit of claim 31, wherein the LED module includes a one-dimensional LED array; and
wherein the control module is configured to illuminate one or more select LEDs along the one-dimensional LED array to indicate a lateral position of the detected object or a proximity distance of the detected object.

33. The retrofit kit of claim 32, wherein the control module is configured to illuminate the one or more select LEDs with selected one or more colors of a plurality of colors to indicate the proximity distance and to illuminate the one or more select LEDs at selected one or more location along the one-dimensional LED array to indicate the lateral position.

34. The retrofit kit of claim 33, wherein the control module is configured to select the one or more colors to indicate the proximity distance based on a rated speed of the power machine.

35. The retrofit kit of claim 29, wherein the detection module includes a magnetic coupler to magnetically secure the detection module to the power machine.

36. A control system for a power machine, the control system comprising:
an object detection sensor arranged to monitor a detection zone for objects along a path of travel of the power machine;
a control module configured to execute operations including:
when the power machine is moving along the path of travel, receiving signals from the object detection sensor that indicate detected objects in the detection zone;
selectively providing an alert to an operator of the power machine for one or more of the detected objects, including:
determining, based on the received signals, a direction of movement of a plurality of detected objects relative to the power machine; and
providing the alert for the one or more detected objects based on the determined direction.

37. The control system of claim 36, wherein the control module is configured to provide a first alert based on the determined one or more directions of movement for the one or more detected objects corresponding to a decreasing distance between the one or more objects and the power machine and not to provide the first alert based on the determined one or more directions corresponding to an increasing distance between the one or more objects and the power machine.

38. A method of retrofitting a power machine, the method comprising:
securing a detection module to the power machine, with the detection module aligned to detect objects along a direction of travel of the power machine in electronic communication with a control module; and
installing a power module to be engaged with a power connection of the power machine to receive power from a power source of a power machine to power one or more of the detection module or the control module;
wherein the detection module is thus arranged in communication with the control module so as to provide signals corresponding to objects detected by the detection module, and the control module is configured to provide to an operator of the power machine one or more indicators of an object detected by the detection module.

39. The method of claim 38, wherein the power module is removably installed on the power machine; and
wherein removably installing the power module includes removably engaging the power module with an auxiliary power connector of the power machine.

40. The method of claim 38, wherein the detection module is removably secured to the power machine.

41. The method of claim 40, wherein removably securing the detection module includes magnetically securing the detection module at a rear of the power machine.

42. The method of claim 38, further comprising installing a display module on the power machine in electronic communication with the control module.

43. The method of claim 42, wherein the display module is removably installed on the power machine.

44. The method of claim 43, wherein removably installing the display module includes removably installing a one-dimensional LED array in an operator station of the power machine.

45. The method of claim 43, wherein removably installing the display module includes removably installing a display screen to display the one or more indicators within an operator station of the power machine.
